(19) United States
(12) Patent Application Publication
(10) Pub. No.: US 2025/0299632 A1
(43) Pub. Date: Sep. 25, 2025

(54) DISPLAY DEVICE AND ELECTRONIC APPARATUS

(71) Applicant: SEIKO EPSON CORPORATION, Tokyo (JP)

(72) Inventors: Hitoshi OTA, SHIOJIRI-SHI (JP); Takehiko KUBOTA, MATSUMOTO-SHI (JP); Tsuyoshi TAMURA, HARA-MURA (JP)

(73) Assignee: SEIKO EPSON CORPORATION, Tokyo (JP)

(21) Appl. No.: 19/087,621

(22) Filed: Mar. 24, 2025

(30) Foreign Application Priority Data
Mar. 25, 2024 (JP) 2024-048495

(51) Int. Cl. G09G 3/3233

(52) U.S. Cl. CPC G09G 3/3233; G09G 2300/043; G09G 2310/08

(57) ABSTRACT

A display device that includes a plurality of first light-emitting elements, a plurality of second light-emitting elements, a data transfer line, a first data line extending in a first direction, a second data line extending in the first direction and adjacent to the first data line along the first direction, a plurality of first pixel circuits coupled to the first data line and respectively coupled to the plurality of first light-emitting elements, a plurality of second pixel circuits coupled to the second data line and respectively coupled to the plurality of second light-emitting elements, a first switch circuit that controls electrical coupling between the first data line and a data transfer line, and a second switch circuit that controls electrical coupling between the second data line and the data transfer line. In a plan view, the first switch circuit overlaps at least one of the plurality of first light-emitting elements.

The present application is based on, and claims priority from JP Application Serial Number 2024-048495, filed Mar. 25, 2024, the disclosure of which is hereby incorporated by reference herein in its entirety.

### BACKGROUND

### 1. Technical Field

The present disclosure relates to a display device and an electronic apparatus.

### 2. Related Art

There has been known a display device including a light-emitting element such as an organic electroluminescence (EL) element. In this display device, a large number of pixel circuits including a plurality of transistors used for driving the light-emitting element or controlling light emission timing are coupled to one data line.

For example, JP 2021-96418 A discloses a display device in which a threshold voltage of a driving transistor of a light-emitting element is held at one end of a coupling capacitance provided between a data line and a pixel circuit, and then data is written to the pixel circuit from another end of the coupling capacitance by a voltage change according to gradation data.

However, in the display device described in JP 2021-96418 A, when a load capacitance of the data line increases with an increase in the number of pixels and an increase in a screen size due to high definition of a display image, it is difficult to drive the data line at high speed, and a time for initializing a voltage of the data line and a time required for writing data become longer.

### SUMMARY

An aspect of a display device according to the present disclosure includes
a plurality of first light-emitting elements,
a plurality of second light-emitting elements,
a data transfer line,
a first data line extending in a first direction,
a second data line extending in the first direction and adjacent to the first data line along the first direction,
a plurality of first pixel circuits coupled to the first data line and respectively coupled to the plurality of first light-emitting elements,
a plurality of second pixel circuits coupled to the second data line and respectively coupled to the plurality of second light-emitting elements,
a first switch circuit configured to control electrical coupling between the first data line and the data transfer line, and
a second switch circuit configured to control electrical coupling between the second data line and the data transfer line, wherein
the first data line is supplied with a signal for causing each of the plurality of first light-emitting elements to emit light from the data transfer line via the first switch circuit,
the second data line is supplied with a signal for causing each of the plurality of second light-emitting elements to emit light from the data transfer line via the second switch circuit, and
in a plan view, the first switch circuit overlaps at least one of the plurality of first light-emitting elements.

An aspect of an electronic apparatus according to the present disclosure includes an aspect of the display device described above.

### BRIEF DESCRIPTION OF THE DRAWINGS

FIG. 1 is a perspective view schematically illustrating a display device of the embodiment.

FIG. 2 is a plan view schematically illustrating a display panel of the display device.

FIG. 3 is a block diagram illustrating an electrical configuration of the display device of a first embodiment.

FIG. 4 is a diagram illustrating a configuration of a pixel circuit and a data potential generating circuit.

FIG. 5 is a timing chart illustrating an example of waveforms of various signals in the display device.

FIG. 6 is a diagram for explaining operation of the display device.

FIG. 7 is a diagram for explaining the operation of the display device.

FIG. 8 is a diagram for explaining the operation of the display device.

FIG. 9 is a diagram for explaining the operation of the display device.

FIG. 10 is a cross-sectional view schematically illustrating a part of the display panel.

FIG. 11 is a plan view illustrating a configuration example of a layout of a part of pixel circuit blocks BLK-1 and BLK-2 in the first embodiment.

FIG. 12 is a plan view illustrating in more detail a layout of a part of each pixel circuit block in the first embodiment.

FIG. 13 is a block diagram illustrating an electrical configuration of a display device of a second embodiment.

FIG. 14 is a plan view illustrating a configuration example of a layout of a part of the pixel circuit blocks BLK-1 and BLK-2 in the second embodiment.

FIG. 15 is a plan view illustrating in more detail a layout of a part of each pixel circuit block in the second embodiment.

FIG. 16 is a perspective view schematically illustrating a head-mounted display according to the embodiment.

FIG. 17 is a diagram schematically illustrating an image forming device and a light-guiding device of the head-mounted display according to the embodiment.

### DESCRIPTION OF EMBODIMENTS

A preferred embodiment of the present disclosure is described in detail below using to the drawings. Note that the embodiments described below do not unduly limit the content of the present disclosure described in the claims. In addition, not all the configurations described below are essential constituent elements of the present disclosure.

### 1. Display Device

### 1-1. First Embodiment

### 1-1-1. Overall Configuration of Display Device

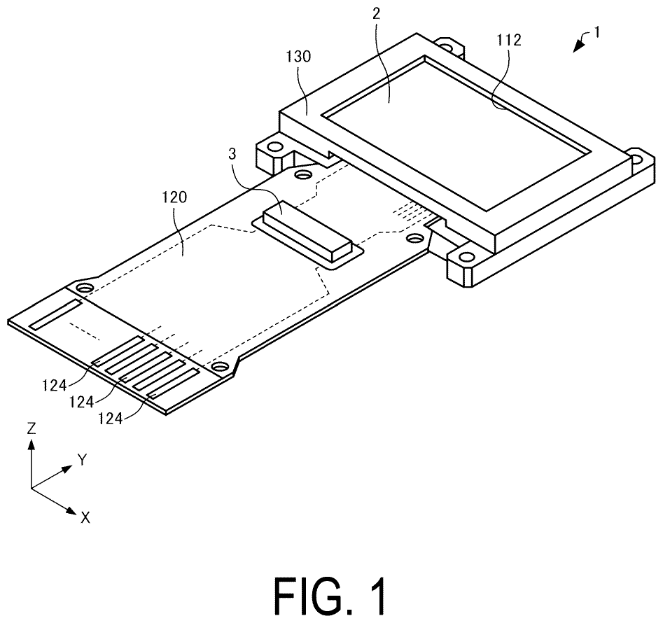

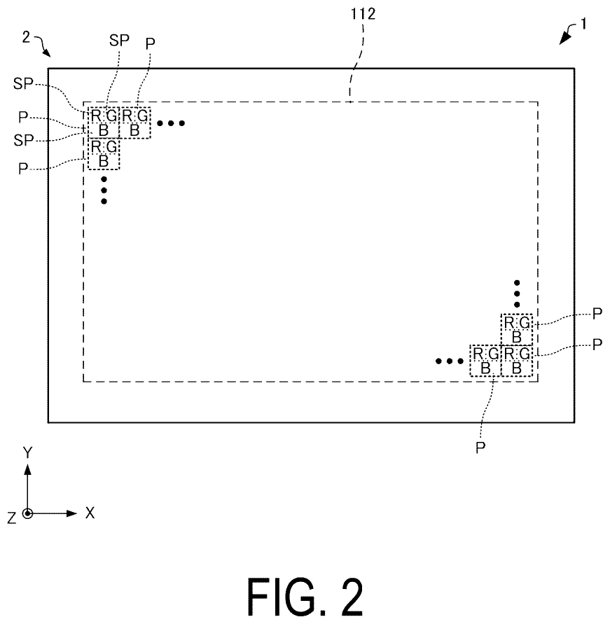

FIG. 1 is a perspective view schematically illustrating a display device 1 of the embodiment. FIG. 2 is a plan view schematically illustrating a display panel 2 of the display device 1 of the embodiment. Note that FIGS. 1 and 2 each illustrate an X-axis, a Y-axis, and a Z-axis as three axes orthogonal to each other.

The display device 1 is a micro display configured to display a color image, for example, in an HMD. HMD is an abbreviation for Head Mounted Display.

As illustrated in FIG. 1, the display device 1 includes the display panel 2, an FPC board 120, and a case 130. FPC is an abbreviation for Flexible Printed Circuit.

The display panel 2 includes a plurality of light-emitting elements, a plurality of pixel circuits respectively coupled to the plurality of light-emitting elements, and a driving circuit that drives the pixel circuits. In the embodiment, the plurality of light-emitting elements, the plurality of pixel circuits and the driving circuit included in the display panel 2 are formed at a silicon substrate, and an OLED is used for the light-emitting element. OLED is an abbreviation for Organic Light emitting Diode.

As illustrated in FIG. 2, the display panel 2 includes a display region 112. In the example illustrated in the drawing, the display region 112 is a rectangle with long sides parallel to the X-axis. In the display region 112, a plurality of pixels P as display units are displayed in a matrix at a predetermined arrangement pitch. In the example illustrated in the drawing, the plurality of pixels P are displayed in a matrix in the X-axis direction and the Y-axis direction. In the following description, it is assumed that m×n pixels P are displayed in m rows in the Y-axis direction and n columns in the X-axis direction. Note that each of m and n is an integer greater than or equal to two. Note that the pitch refers to, when a plurality of elements are arranged along a predetermined direction, a distance along the predetermined direction from an end of one element on one side in the predetermined direction to an end of an adjacent element on the one side in the predetermined direction.

The pixel P may have luminance information and may further have color information. When the pixel P has luminance information and does not have color information, a black and white image is displayed in the display region 112. On the other hand, when the pixel P has luminance information and color information, a color image is displayed in the display region 112. Hereinafter, description will be given assuming that the pixel P has luminance information and color information.

Each of the m×n pixels P includes three sub-pixels SP having a red color, a green color, and a blue color, respectively.

As illustrated in FIG. 1, the display panel 2 is housed and fixed at the frame-shaped case 130 that opens in the display region 112, and one end of the FPC board 120 is coupled thereto. Another end of the FPC board 120 is provided with a plurality of external coupling terminals 124, and the plurality of external coupling terminals 124 are coupled to an external circuit (not illustrated). A control circuit 3 being a semiconductor chip is mounted at the FPC board 120 by a COF technique, and synchronization signals and image data synchronized with the synchronization signals are supplied from the external circuit via the plurality of external coupling terminals 124. COF is an abbreviation for Chip On Film. The synchronization signals include a vertical synchronization signal for giving an instruction for starting vertical scanning of image data, a horizontal synchronization signal for giving an instruction for starting horizontal scanning of the image data, and a dot clock signal that indicates timing corresponding to one pixel of the image data.

The control circuit 3 supplies various control signals and various potentials generated according to the synchronization signal to the display panel 2, and supplies data corresponding to each pixel P included in the image data to the display panel 2 in a time-division manner.

### 1-1-2. Functional Configuration of Display Device

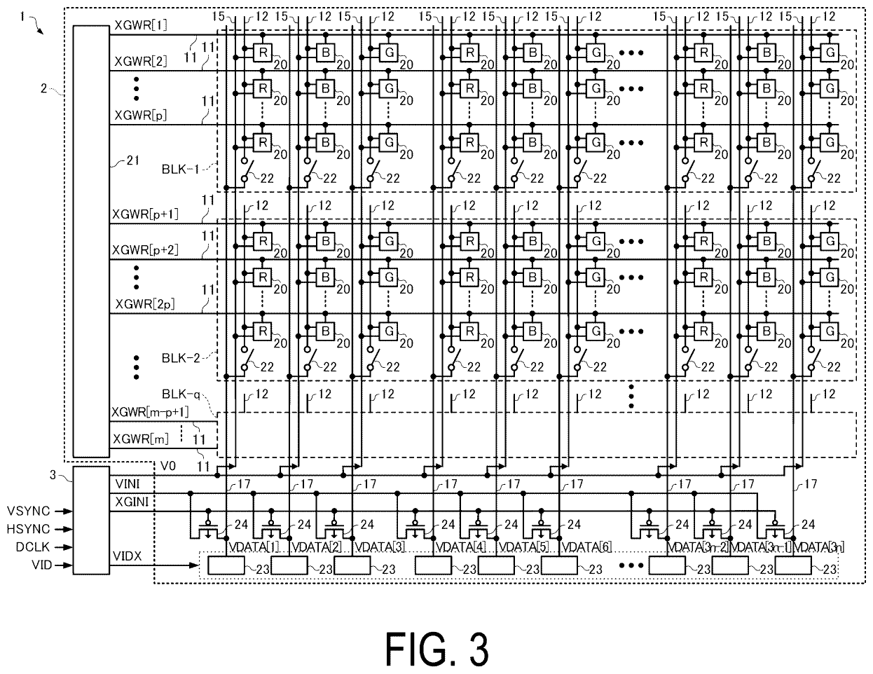

FIG. 3 is a block diagram illustrating an electrical configuration of the display device 1 of the first embodiment. As illustrated in FIG. 3, the display device 1 includes the control circuit 3, a plurality of pixel circuits 20, a scanning line driving circuit 21, a plurality switch circuits 22, a plurality of data potential generating circuits 23, and a plurality of P-channel type MOSFETs 24. The plurality of pixel circuits 20, the scanning line driving circuit 21, the plurality of switch circuits 22, the plurality of data potential generating circuits 23, and the plurality of P-channel type MOSFETs 24 are provided at the display panel 2. As described above, the control circuit 3 is mounted at the FPC board 120, but may be provided at the display panel 2.

The display panel 2 is provided with m scanning lines 11 along a lateral direction in the drawing, and 3n data transfer lines 17 along a vertical direction in the drawing. In FIG. 3, the lateral direction corresponds to a direction of the X-axis in FIGS. 1 and 2, and the vertical direction corresponds to a direction of the Y-axis in FIGS. 1 and 2. Then, m×3n pixel circuits 20 are provided corresponding to the m scanning lines 11 and the 3n data transfer lines 17. That is, one pixel circuit 20 is provided corresponding to one scanning line 11 and one data transfer line 17, and the m×3n pixel circuits 20 are arrayed in a matrix of m rows in the vertical direction and 3n columns in the lateral direction.

The m×3n pixel circuits 20 are divided into q pixel circuit blocks BLK-1 to BLK-q in which p×3n pixel circuits 20 coupled to any of p scanning lines 11 form one pixel circuit block. p, q are integers equal to or greater than 2 that satisfy p×q=m. In FIG. 3, the pixel circuit block BLK-1 which is first from a top includes p×3n pixel circuits 20 coupled to any of the p scanning lines 11 in a first row to a p-th row. In addition, the second pixel circuit block BLK-2 includes p×3n pixel circuits 20 coupled to any of the p scanning lines 11 in a (p+1)-th row to a 2p-th row. When generalized, a k-th pixel circuit block BLK-k includes p×3n pixel circuits 20 coupled to any of the p scanning lines 11 in a {(k−1)×p+1}-th row to a (k×p)-th row. k is an integer from 1 to q.

Each pixel circuit block BLK-k is provided with 3n data lines 12 along the vertical direction, and p pixel circuits 20 are coupled to each data line 12. The 3n data lines 12 form groups each including three lines, and are divided into n groups. Among the n groups, a j-th group from a left includes the data line 12 in a (3j−2)-th column, the data line 12 in a (3j−1)-th column, and the data-line 12 in a 3j-th column. Note that j is an integer from 1 to n. n pixel circuits 20 that respectively cause n red sub-pixels SP to emit light are coupled to the data line 12 in the (3j−2)-th column, n pixel circuits 20 that respectively cause n blue sub-pixels SP to emit light are coupled to the data line 12 in the (3j−1)-th column, and n pixel circuits 20 that respectively cause n green sub-pixels SP to emit light are coupled to the data line 12 in the 3j-th column. In FIG. 3, the pixel circuit 20 that causes the red sub-pixel SP to emit light is denoted by “R”, the pixel circuit 20 that causes the blue sub-pixel SP to emit light is denoted by “B”, and the pixel circuit 20 that causes the green sub-pixel to emit light is denoted by “G”.

In addition, each pixel circuit block BLK-k includes 3n switch circuits 22, and the 3n switch circuits 22 respectively control electrical coupling between 3n data lines 12 and 3n data transfer lines 17 in accordance with control by the control circuit 3. That is, when a switch circuit 22 is on, a data line 12 and a data transfer line 17 are electrically coupled to each other, and when the switch circuit 22 is off, the data line 12 and the data transfer line 17 are electrically disconnected from each other. Specifically, when the switch circuit 22 coupled to the data line 12 in the (3j−2)-th column is on, the data line 12 in the (3j−2)-th column is electrically coupled to the data transfer line 17 in the (3j−2)-th column, and when the switch circuit 22 coupled to the data line 12 in the (3j−1)-th column is on, the data line 12 in the (3j−1)-th column is electrically coupled to the data transfer line 17 in the (3j−1)-th column, and when the switch circuit 22 coupled to the data line 12 in the 3j-th column is on, the data line 12 in 3j-th column is electrically coupled to the data transfer line 17 in the 3j-th column.

The 3n data transfer lines 17 are coupled to drain of 3n MOSFETs 24, respectively. Sources of the respective 3n MOSFETs 24 are commonly supplied with a potential VINI from the control circuit 3, and gates of the respective 3n MOSFETs 24 are commonly supplied with a control signal XGINI from the control circuit 3.

Further, the display panel 2 is provided with 3n power supply lines 15 along the vertical direction. m pixel circuits 20 corresponding to the red sub-pixels SP of respective m pixels P in a j-th column are coupled to the power suppl line 15 in the (3j−2)-th column, m pixel circuits 20 corresponding to the blue sub-pixels SP of respective m pixels P in the j-th column are coupled to the power supply line 15 in the (3j−1)-th column, and m pixel circuits 20 corresponding to the green sub-pixels SP of respective m pixels P in the j-th column are coupled to the power supply line 15 in the 3j-th column. The 3n power supply lines 15 are commonly supplied with a potential V0 from the control circuit 3. Note that the potential V₀ is, for example, a ground potential VSS that is a reference of a zero potential, or a potential close to the ground potential VSS. To be specific, the potential V₀ is a potential so small that when applied to a light-emitting element, a current does not flow through the light-emitting element.

The control circuit 3 controls each unit, based on image data VID, a vertical synchronization signal VSYNC, a horizontal synchronization signal HSYNC, and a dot clock signal DCLK that are supplied from the external circuit. The image data VID is data that defines a gray scale level of each pixel P of an image to be displayed in the display region 112 for each of RGB, using 8 bits, for example. That is, the image data VID is data in which 24-bit RGB data corresponding to luminance information and color information of each pixel P is switched for each cycle of the dot clock signal DCLK.

Here, brightness characteristics indicated by a gray scale level does not coincide with luminance characteristics of a light-emitting element, and thus the control circuit 3 converts the image data VID that designates the gray scale level of the pixel P into image data VIDX that designates a luminance corresponding to the gray scale level. That is, the control circuit 3 generates the image data VIDX by performing up-conversion of 8 bits of R data, 8 bits of G data, and 8 bits of B data of each pixel P included in the image data VID into, for example, 10 bits of R data, 10 bits of G data, and 10 bits of B data, respectively, for designating a luminance of a corresponding light-emitting element. For such up-conversion, a look-up table is used in which correspondence relationships between 8 bits of R data, 8 bits of G data, and 8 bits of B data and 10 bits of R data, 10 bits of G data, and 10 bits of B data are stored in advance.

The scanning line driving circuit 21 is a circuit for driving the pixel circuits 20 arrayed in the m rows and 3n columns row by row in accordance with the control by the control circuit 3, and outputs various types of signals. For example, the scanning line driving circuit 21 supplies scanning signals XGWR[1] to XGWR[m] to the scanning lines 11 in first to m-th rows in order, respectively. That is, the scanning line 11 in the i-th row is supplied with a scanning signal XGWR[i].

One data potential generating circuit 23 is provided for one data transfer line 17. That is, the display panel 2 includes 3n data potential generating circuits 23.

A (3j−2)-th data potential generating circuit 23 from the left generates a data potential VDATA[3j−2] to be supplied to the data transfer line 17 in the (3j−2)-th column according to the control by the control circuit 3 and based on the image data VIDX supplied from the control circuit 3. Similarly, a (3j−1)-th data potential generating circuit 23 from the left generates a data potential VDATA[3j−1] to be supplied to the data transfer line 17 in the (3j−1)-th column according to the control by the control circuit 3 and based on the image data VIDX supplied from the control circuit 3. Similarly, a 3j-th data potential generating circuit 23 from the left generates a data potential VDATA[3j] to be supplied to the data transfer line 17 in the 3j-th column according to the control by the control circuit 3 and based on the image data VIDX supplied from the control circuit 3. To be specific, the (3j−2)-th data potential generating circuit 23 includes a capacitive DAC, and the capacitive DAC acquires R data of the pixel P in the i-th row and the j-th column included in the image data VIDX at timing designated by the control circuit 3, performs D/A conversion, and outputs the data potential VDATA[3j−2] to the data transfer line 17 in the (3j−2)-th column. Further, the (3j−1)-th data potential generating circuit 23 includes a capacitive DAC, and the capacitive DAC acquires B data of the pixel P in the i-th row and the j-th column included in the image data VIDX at timing designated by the control circuit 3, performs D/A conversion, and outputs the data potential VDATA[3j−1] to the data transfer line 17 in the (3j−1)-th column. Further, the 3j-th data potential generating circuit 23 includes a capacitive DAC, and the capacitive DAC acquires G data of the pixel P in the i-th row and the j-th column included in the image data VIDX at timing designated by the control circuit 3, performs D/A conversion, and outputs the data potential VDATA[3j] to the data transfer line 17 in the 3j-th column.

Note that various control signals and various potentials are supplied to the display panel 2 by the control circuit 3, but are only partially illustrated in FIG. 3.

### 1-1-3. Configuration of Pixel Circuit and Data Potential Generating Circuit

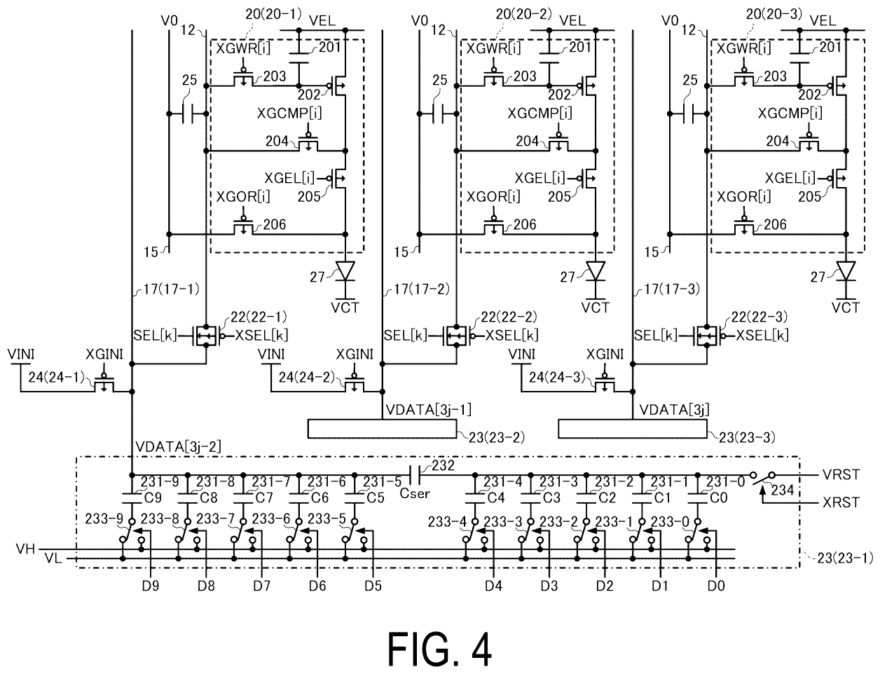

FIG. 4 is a diagram illustrating a configuration of three pixel circuits 20 and three data potential generating circuits 23 corresponding to the pixel P in the i-th row and the j-th column. The three pixel circuits 20 are included in the k-th pixel circuit block BLK-k. For convenience of description, in FIG. 4, the three pixel circuits 20 corresponding to the pixel P in the i-th row and the j-th column are distinguished as pixel circuits 20-1, 20-2, and 20-3, respectively, but configurations of the three pixel circuits 20 are the same, and the same components are denoted by the same reference numerals. The pixel circuit 20-1 is the pixel circuit 20 corresponding to the red sub-pixel SP of the pixel P, the pixel circuit 20-2 is the pixel circuit 20 corresponding to the blue sub-pixel SP of the pixel P, and the pixel circuit 20-3 is the pixel circuit 20 corresponding to the green sub-pixel of the pixel P.

In addition, in FIG. 4, three light-emitting elements 27 respectively coupled to the pixel circuits 20-1, 20-2, and 20-3 are distinguished as light-emitting elements 27-1, 27-2, and 27-3, but the three light-emitting elements 27 have the same configuration. In addition, in FIG. 4, the three data potential generating circuits 23 are distinguished as data potential generating circuits 23-1, 23-2, and 23-3, respectively, but the three data potential generating circuits 23 have the same configuration, and only the configuration of the data potential generating circuit 23-1 is illustrated. The data potential generating circuits 23-1, 23-2, and 23-3 are the (3j−2)-th, (3j−1)-th, and 3j-th data potential generating circuits 23, respectively. In addition, in FIG. 4, three data transfer lines 17 respectively coupled to the data potential generating circuits 23-1, 23-2, and 23-3 are distinguished as data transfer lines 17-1, 17-2, and 17-3, respectively. Further, three switch circuits 22 respectively coupled to the data transfer lines 17-1, 17-2, and 17-3 are distinguished as switch circuits 22-1, 22-2, and 22-3, respectively, but the three switch circuits 22 have the same configuration. In addition, three MOSFETs 24 respectively coupled to the data transfer lines 17-1, 17-2, and 17-3 are distinguished as MOSFETs 24-1, 24-2, and 24-3, respectively, but the three MOSFETs 24 have the same configuration.

As illustrated in FIG. 4, the pixel circuit 20 includes a capacitance element 201, and P-channel type MOSFETs 202 to 206, and is coupled to the light-emitting element 27. MOSFET is an abbreviation for Metal Oxide Semiconductor Field Effect Transistor.

The light-emitting element 27 is an OLED, and has a structure in which a light-emitting functional layer is sandwiched between a pixel electrode and a common electrode (not illustrated). The pixel electrode functions as an anode, the common electrode has optical transparency, and functions as a cathode. In the light-emitting element 27, when a current flows from the anode toward the cathode, holes injected from the anode and electrons injected from the cathode are recombined in the light-emitting functional layer to generate excitons, and white light is generated. Then, the generated white light resonates in an optical resonator configured of a reflective layer and a semi-reflective and semi-transmissive layer (not illustrated), and is emitted at a resonance wavelength set corresponding to any of red, green, and blue. A color filter corresponding to the color is provided on an emission side of light from the optical resonator. Thus, the emitted light from the light-emitting element 27 is visually recognized by an observer through coloration by the optical resonator and the color filter. Note that when a black-and-white image is displayed in the display region 112, the color filter is omitted.

One end of the capacitance element 201 is supplied with a potential VEL from the control circuit 3, and another end of the capacitance element 201 is coupled to a gate of the MOSFET 202 and a drain of the MOSFET 203. A source of the MOSFET 202 is supplied with the potential VEL, and a drain of the MOSFET 202 is coupled to a drain of the MOSFET 204 and a source of the MOSFET 205. A drain of the MOSFET 205 is coupled to a drain of the MOSFET 206 and the anode of the light-emitting element 27. The cathode of the light-emitting element 27 is supplied with a potential VCT from the control circuit 3.

A source of the MOSFET 203 and a source of the MOSFET 204 are coupled to the data line 12. A source of the MOSFET 206 is coupled to the power supply line 15 and is supplied with the potential V₀ from the control circuit 3.

The scanning signal XGWR[i] is input from the scanning line driving circuit 21 to a gate of the MOSFET 203. A control signal XGCMP[i] is input from the scanning line driving circuit 21 to a gate of the MOSFET 204. A control signal XGEL[i] is input from the scanning line driving circuit 21 to a gate of the MOSFET 205. A control signal XGOR[i] is input from the scanning line driving circuit 21 to a gate of the MOSFET 206.

The MOSFET 202 supplies a current corresponding to a voltage between the gate and the source to the light-emitting element 27. To be more specific, as the voltage between the gate and the source of the MOSFET 202 becomes higher, a current flowing through the light-emitting element 27 becomes larger and an amount of light emitted from the light-emitting element 27 becomes larger.

The MOSFET 203 controls the electrical coupling between the data line 12 and the gate of the MOSFET 202 according to a potential of the scanning line 11. To be more specific, when the scanning signal XGWR[i] supplied to the scanning line 11 is at an L level, the MOSFET 203 is on and the data line 12 and the gate of the MOSFET 202 are electrically coupled to each other, and when the scanning signal XGWR[i] is at an H level, the MOSFET 203 is off and the data line 12 and the gate of the MOSFET 202 are electrically disconnected from each other.

The MOSFET 204 controls the electrical coupling between the data line 12 and the drain of the MOSFET 202. To be specific, when the control signal XGCMP[i] is at the L level, the MOSFET 204 is on and the data line 12 and the drain of the MOSFET 202 are electrically coupled to each other, and when the control signal XGCMP[i] is at the H level, the MOSFET 204 is off and the data line 12 and the drain of the MOSFET 202 are electrically disconnected from each other.

The MOSFET 205 controls electrical coupling between the light-emitting element 27 and the drain of the MOSFET 202. To be specific, when the control signal XGEL[i] is at the L level, the MOSFET 205 is on and the anode of the light-emitting element 27 and the drain of the MOSFET 202 are electrically coupled to each other, and when the control signal XGEL[i] is at the H level, the MOSFET 205 is off and the anode of the light-emitting element 27 and the drain of the MOSFET 202 are electrically disconnected from each other.

The MOSFET 206 controls electrical coupling between the power supply line 15 and the light-emitting element 27. To be specific, when the control signal XGOR[i] is at the L level, the MOSFET 206 is on and the power supply line 15 and the anode of the light-emitting element 27 are electrically coupled to each other, and when the control signal XGOR[i] is at the H level, the MOSFET 206 is off and the power supply line 15 and the anode of the light-emitting element 27 are electrically disconnected from each other.

As illustrated in FIG. 4, a capacitor 25 is provided between the data line 12 coupled to the pixel circuit 20 and the power supply line 15. The capacitor 25 may be a parasitic capacitor between the data line 12 and the power supply line 15, or may be a capacitor formed by sandwiching an insulating layer between mutually different conductive layers at a silicon substrate.

As illustrated in FIG. 4, the switch circuit 22 is a transmission gate in which sources and drains of an N-channel type MOSFET and a P-channel type MOSFET are coupled, respectively. Hereinafter, in the switch circuit 22, a gate of the N-channel MOSFET is referred to as a “first control terminal”, a gate of the P-channel MOSFET is referred to as a “second control terminal”, a coupling node between a source of the N-channel MOSFET and a source of the P-channel MOSFET is referred to as an “input terminal”, and a coupling node between a drain of the N-channel MOSFET and a drain of the P-channel MOSFET is referred to as an “output terminal”.

A source of the MOSFET 24-1 is supplied with the potential VINI from the control circuit 3, and a drain of the MOSFET 24-1 is coupled to the data line 12 coupled to the pixel circuit 20-1. An input terminal of the switch circuit 22-1 is coupled to the data transfer line 17-1, and an output terminal of the switch circuit 22-1 is coupled to the data line 12 coupled to the pixel circuit 20-1.

Similarly, a source of the MOSFET 24-2 is supplied with the potential VINI from the control circuit 3, and a drain of the MOSFET 24-2 is coupled to the data line 12 coupled to the pixel circuit 20-2. An input terminal of the switch circuit 22-2 is coupled to the data transfer line 17-2, and an output terminal of the switch circuit 22-2 is coupled to the data line 12 coupled to the pixel circuit 20-2.

Similarly, a source of the MOSFET 24-3 is supplied with the potential VINI from the control circuit 3, and a drain of the MOSFET 24-3 is coupled to the data line 12 coupled to the pixel circuit 20-3. An input terminal of the switch circuit 22-3 is coupled to the data transfer line 17-3, and an output terminal of the switch circuit 22-3 is coupled to the data line 12 coupled to the pixel circuit 20-3.

The control signal XGINI is input from the control circuit 3 to a gate of each of the MOSFETs 24-1, 24-2, and 24-3. Additionally, a control signal SEL[k] is commonly input from the control circuit 3 to a first control terminal of each of the switch circuits 22-1, 22-2, and 22-3, and a control signal XSEL[k] is commonly input from the control circuit 3 to a second control terminal of each of the switch circuits 22-1, 22-2, and 22-3. The control signal SEL[k] and the control signal XSEL[k] are digital signals for which logic levels are inverted from each other.

The MOSFET 24-1 controls supply of the potential VINI to the data transfer line 17-1. The MOSFET 24-2 controls supply of the potential VINI to the data transfer line 17-2. The MOSFET 24-3 controls supply of the potential VINI to the data transfer line 17-3. To be specific, when the control signal XGINI is at the L level, the MOSFET 24-1 is on and the data transfer line 17-1 is supplied with the potential VINI, the MOSFET 24-2 is on and the data transfer line 17-2 is supplied with the potential VINI, and the MOSFET 24-3 is on and the data transfer line 17-3 is supplied with the potential VINI. Further, when the control signal XGINI is at the H level, the MOSFET 24-1 is off and the data transfer line 17-1 is not supplied with the potential VINI, the MOSFET 24-2 is off and the data transfer line 17-2 is not supplied with the potential VINI, and the MOSFET 24-3 is off and the data transfer line 17-3 is not supplied with the potential VINI.

The switch circuit 22-1 controls electrical coupling between the data line 12 coupled to the pixel circuit 20-1 and the data transfer line 17-1. The switch circuit 22-2 controls electrical coupling between the data line 12 coupled to the pixel circuit 20-2 and the data transfer line 17-2. The switch circuit 22-3 controls electrical coupling between the data line 12 coupled to the pixel circuit 20-3 and the data transfer line 17-3. Specifically, when the control signals SEL[k] and XSEL[k] are at the H level and the L level, respectively, the switch circuit 22-1 is on and the data line 12 coupled to the pixel circuit 20-1 and the data transfer line 17-1 are electrically coupled to each other, the switch circuit 22-2 is on and the data line 12 coupled to the pixel circuit 20-2 and the data transfer line 17-2 are electrically coupled to each other, and the switch circuit 22-3 is on and the data line 12 coupled to the pixel circuit 20-3 and the data transfer line 17-3 are electrically coupled to each other. Further, when the control signals SEL[k] and XSEL[k] are at the L level and the H level, respectively, the switch circuit 22-1 is off and the data line 12 coupled to the pixel circuit 20-1 and the data transfer line 17-1 are electrically disconnected from each other, the switch circuit 22-2 is off and the data line 12 coupled to the pixel circuit 20-2 and the data transfer line 17-2 are electrically disconnected from each other, and the switch circuit 22-3 is off and the data line 12 coupled to the pixel circuit 20-3 and the data transfer line 17-3 are electrically disconnected from each other.

Then, when the data line 12 coupled to the pixel circuit 20-1 and the data transfer line 17-1 are electrically coupled to each other by the switch circuit 22-1, the data potential VDATA[3j−2] is transferred from the data transfer line 17-1 to the data line 12. Similarly, when the data line 12 coupled to the pixel circuit 20-2 and the data transfer line 17-2 are electrically coupled to each other by the switch circuit 22-2, the data potential VDATA[3j−1] is transferred from the data transfer line 17-2 to the data line 12. Similarly, when the data line 12 coupled to the pixel circuit 20-3 and the data transfer line 17-3 are electrically coupled to each other by the switch circuit 22-3, the data potential VDATA[3j] is transferred from the data transfer line 17-3 to the data line 12.

Note that the control signal XGINI is commonly input to the 3n MOSFETs 24, and the control signals SEL[k] and XSEL[k] are commonly input to the 3n switch circuits 22 included in the k-th pixel circuit block BLK-k.

As illustrated in FIG. 4, 10-bit image data VIDX which is switched to R data, B data, and G data of the pixels P in the j-th column in a time division manner is input from the control circuit 3 to the data potential generating circuits 23-1, 23-2, and 23-3. In FIG. 4, D9, D8, D7, D6, D5, D4, D3, D2, D1, and D0 are denoted in order from a highest bit of the image data VIDX.

The data potential generating circuit 23-1 includes a capacitive DAC including capacitance elements 231-0 to 231-9, 232, switch circuits 233-0 to 233-9, and 234.

One end of each of the capacitance elements 231-0 to 231-4 and an output terminal of the switch circuit 234 are coupled to one end of the capacitance element 232. One end of each of the capacitance elements 231-5 to 231-9 is coupled to another end of the capacitance element 232 and the data transfer line 17-1. Another ends of the capacitance elements 231-0 to 231-9 are respectively coupled to output terminals of the respective switch circuits 233-0 to 233-9. A first input terminal of each of the switch circuits 233-0 to 233-9 is supplied with a potential VL from the control circuit 3, and a second input terminal of each of the switch circuits 233-0 to 233-9 is supplied with a potential VH higher than the potential VL from the control circuit 3. The bits DO to D9 of the image data VIDX are respectively input from the control circuit 3 to control terminals of the respective switch circuits 233-0 to 233-9. In a switch circuit 233-r, a first input terminal and an output terminal are electrically coupled to each other when a bit Dr is at the L level, and a second input terminal and the output terminal are electrically coupled to each other when the bit Dr is at the H level. That is, the switch circuit 233-r outputs the potential VL when the bit Dr is at the L level, and outputs the potential VH when the bit Dr is at the H level. r is an integer from 0 to 9.

When a capacitance value of a capacitance element 231-r is Cr, C0:C1:C2:C3:C4:C5:C6:C7:C8:C9=1:2:4:8:16:1:2:4:8:16, for example. Further, a capacitance value Cser of the capacitance element 232 may be the same as C0 and C5. Note that errors are allowed to some extent for the capacitance values C0 to C9, and Cser as long as linearity is maintained between the value of the 10-bit image data VIDX that is input and the data potential VDATA[3j−2] that is output.

An input terminal of the switch circuit 234 is supplied with a potential VRST from the control circuit 3, and a control signal XRST is input from the control circuit 3 to a control terminal of the switch circuit 234. In the switch circuit 234, when the control signal XRST is at the L level, the input terminal and the output terminal are electrically coupled to each other, and when the control signal XRST is at the H level, the input terminal and the output terminal are not electrically coupled to each other. Therefore, when the control signal XRST is at the L level, the one end of each of the capacitance elements 231-0 to 231-4 and one end of the capacitance element 232 is supplied with the potential VRST. Note that one ends of the capacitance elements 231-5 to 231-9 and the other end of the capacitance element 232 are coupled to the data transfer line 17-1, thus is supplied with the potential VINI when the control signal XGINI is at the L level. Therefore, when the control signal XRST and the control signal XGINI are both at the L level, charges accumulated in the capacitance elements 231-0 to 231-9, and 232 are initialized.

On the other hand, when both the control signal XRST and the control signal XGINI are at the H level, charges corresponding to logic levels of the respective bits D0 to D9 are accumulated in the respective capacitance elements 231-0 to 231-9. The one end of each of the capacitance elements 231-0 to 231-4 is coupled to the one end of the capacitance element 232, thus the one end of the capacitance element 232 has a potential corresponding to the logic levels of the respective bits D0 to D4. In addition, one end of each of the capacitance elements 231-5 to 231-9 is coupled to the other end of the capacitance element 232, thus the other end of the capacitance element 232 has a potential obtained by shifting the potential according to the logic levels of the respective bits D5 to D9 according to the potential of the one end of the capacitance element 232. Therefore, the potential of the other end of the capacitance element 232 changes linearly with respect to the bits D9 to D0, and is supplied to the data transfer line 17-1 as the data potential VDATA[3j−2].

Note that the data potential generating circuits 23-2 and 23-3 have the same configuration as the data potential generating circuit 23-1, and the data potential generating circuit 23-2 generates the data potential VDATA[3j−1] and supplies the data potential VDATA[3j−1] to the data transfer line 17-2, and the data potential generating circuit 23-3 generates the data potential VDATA[3j] and supplies the data potential VDATA[3j] to the data transfer line 17-3.

As described above, under the control of the control circuit 3, the (3j−2)-th data potential generating circuit 23 acquires R data of each of the m pixels P in the j-th column included in the image data VIDX output from the control circuit 3 at timing designated by the control circuit 3, performs D/A conversion, and generates the data potential VDATA[3j−2] to be supplied to the data transfer line 17 in the (3j−2)-th column. Additionally, under the control of the control circuit 3, the (3j−1)-th data potential generating circuit 23 acquires B data of each of the m pixels P in the j-th column included in the image data VIDX output from the control circuit 3 at timing designated by the control circuit 3, performs D/A conversion, and generates the data potential VDATA[3j−1] to be supplied to the data transfer line 17 in the (3j−1)-th column.

Additionally, under the control of the control circuit 3, the 3j-th data potential generating circuit 23 acquires G data of each of the m pixels P in the j-th column included in the image data VIDX output from the control circuit 3 at timing designated by the control circuit 3, performs D/A conversion, and generates the data potential VDATA[3j] to be supplied to the data transfer line 17 in the 3j-th column. Therefore, the data potential, VDATA[3j−2], VDATA[3j−1], and VDATA[3j] are switched in a time division manner at timing when the R data, the B data, or the G data are written to the 3m pixel circuits 20 corresponding to the m pixels P in the j-th column.

### 1-1-4. Operation of Display Device

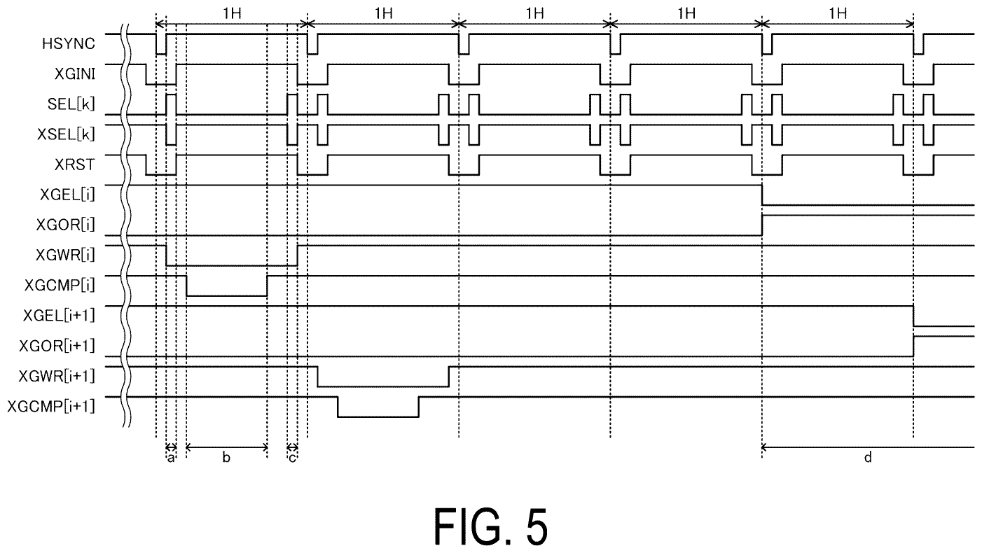

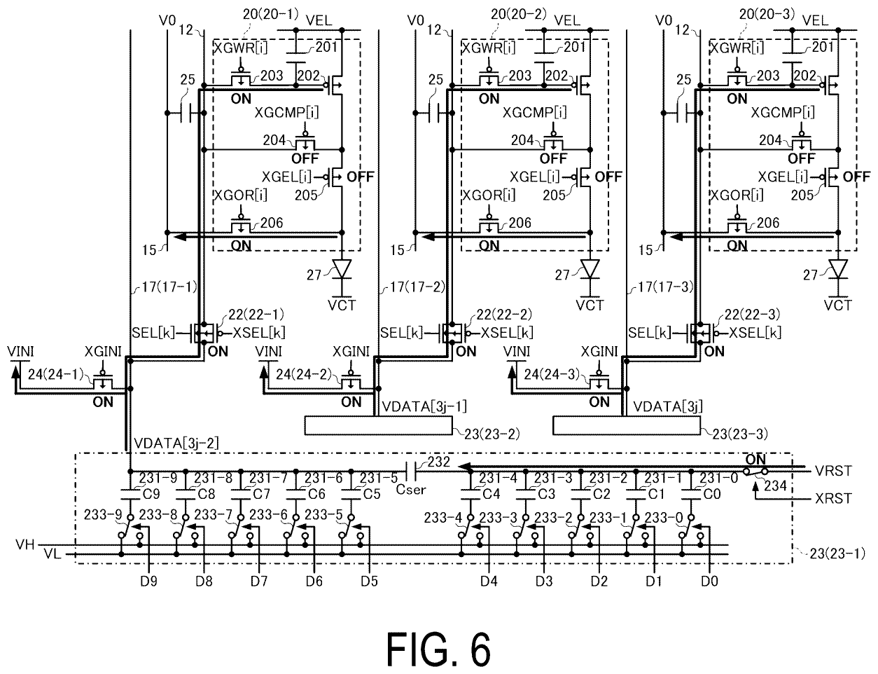

Operation of the display device 1 will be described with reference to FIGS. 5 to 9. FIG. 5 is a timing chart illustrating an example of waveforms of various signals in the display device 1. Further, FIGS. 6 to 9 are diagrams obtained by adding ON/OFF of the MOSFETs and the switch circuits in each period and supply paths of various potentials to FIG. 4.

As illustrated in FIG. 5, a period of one cycle from a time when the horizontal synchronization signal HSYNC input from the external circuit of the display device 1 transitions from the H level to the L level to a time when the horizontal synchronization signal HSYNC next transitions from the H level to the L level corresponds to a horizontal scanning period 1H. In each horizontal scanning period 1H, data is written to 3n pixel circuits 20 corresponding to n pixels P in each row. In each horizontal scanning period 1H, the scanning line driving circuit 21 commonly outputs the control signals XGEL[i], XGOR[i], and XGCMP[i] and the scanning signal XGWR[i] to 3n pixel circuits 20 corresponding to n pixels P in the i-th row. Further, the control circuit 3 commonly outputs the control signal XGINI to n MOSFETs 24. In addition, the control circuit 3 commonly outputs the control signals SEL[k] and XSEL[k] to n switch circuits 22 included in the k-th pixel circuit block BLK-k. Note that FIG. 5 is a timing chart focusing on the horizontal scanning period 1H for the i-th row after the horizontal scanning periods 1H for first to (i−1)-th rows ended. Note that it is assumed that 3n pixel circuits 20 coupled to the scanning line 11 in the i-th row are included in the k-th pixel circuit block BLK-k.

As illustrated in FIG. 5, the horizontal scanning period 1H for the i-th row includes an initialization period a, a compensation period b after the initialization period a, and a writing period c after the compensation period b. Then, after the writing period c, after a while, a light-emitting period d is reached, and after a period of one frame elapses, the horizontal scanning period 1H for the i-th row is reached again. Note that the period of one frame corresponds to a period of one cycle of the vertical synchronization signal VSYNC, and is a period required to display one shot of an image designated by the image data VID. For example, when a frequency of the vertical synchronization signal VSYNC is 60 Hz, the period of one frame is about 16.7 milliseconds.

As illustrated in FIG. 5, in the horizontal scanning period 1H for the i-th row, the scanning signal XGWR[i] is at the L level in the initialization period a. Further, the control signal XGOR[i] is at the L level, and the control signals XGEL[i] and XGCMP[i] are at the H level. Further, the control signals XGINI and XRST are at the L level. Further, the control signal SEL[k] is at the H level, and the control signal XSEL[k] is at the L level. Therefore, as illustrated in FIG. 6, in the initialization period a, the MOSFETs 203 and 206 are on and the MOSFETs 204 and 205 are off in each of the pixel circuits 20-1, 20-2, and 20-3. Further, the MOSFETs 24-1, 24-2, and 24-3 are on, and the switch circuits 22-1, 22-2, and 22-3 are on. Therefore, the potential VINI is supplied from the control circuit 3 to the data transfer lines 17-1, 17-2, and 17-3 via the MOSFETs 24-1, 24-2, 24-3, and the predetermined potential VINI is supplied from the data transfer lines 17-1, 17-2, and 17-3 to the data lines 12 respectively coupled to the pixel circuits 20-1, 20-2, and 20-3 via the respective switch circuits 22-1, 22-2, and 22-3. Then, in each of the pixel circuits 20-1, 20-2, and 20-3, the gate of the MOSFET 202 and the other end of the capacitance element 201 are supplied with the potential VINI via the data line 12. Further, the anode of the light-emitting element 27 is supplied with the potential V0 via the power supply line 15. That is, the potentials of the data line 12, the gate of the MOSFET 202, and the other end of the capacitance element 201 are initialized to the potential VINI, and the potential of the anode of the light-emitting element 27 is initialized to the potential V0. In addition, one end of each of the capacitance elements 231-5 to 231-9 of the capacitive DAC, and the other end of the capacitance element 232 are supplied with the predetermined potential VINI, the one end of each of the capacitance elements 231-0 to 231-4, and the one end of the capacitance element 232 are supplied with the potential VRST, and charges accumulated in the capacitance elements 231-0 to 231-9, and 232 are initialized.

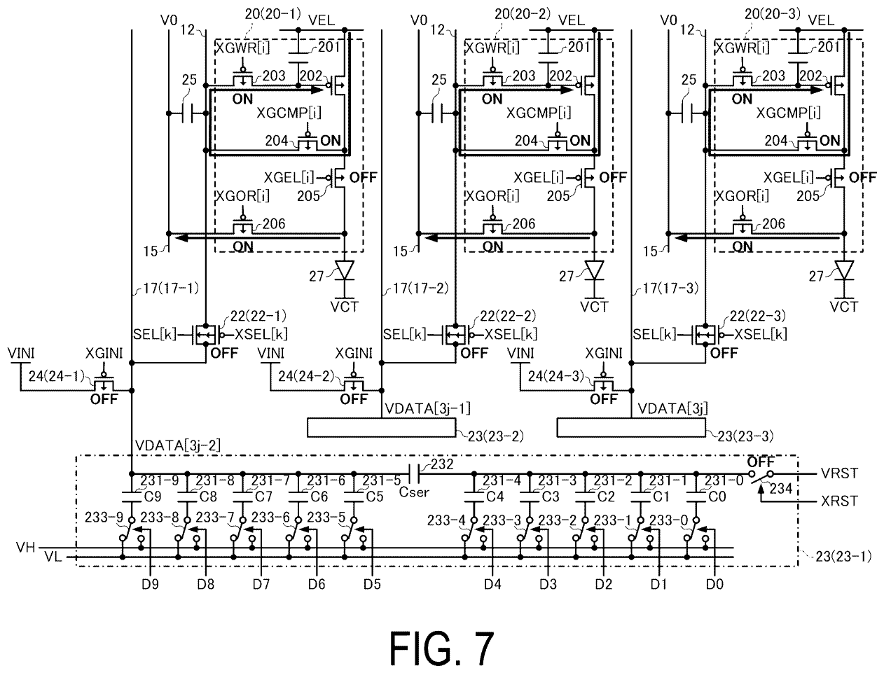

As illustrated in FIG. 5, in the horizontal scanning period 1H for the i-th row, the scanning signal XGWR[i] is at the L level in the compensation period b. Further, the control signals XGOR[i] and XGCMP[i] are at the L level, and the control signal XGEL[i] is at the H level. Further, the control signals XGINI and XRST are at the H level. Further, the control signal SEL[k] is at the L level, and the control signal XSEL[k] is at the H level. Therefore, as illustrated in FIG. 7, in the compensation period b, the MOSFETs 203, 204, and 206 are on and the MOSFET 205 is off in each of the pixel circuits 20-1, 20-2, and 20-3. Further, the MOSFETs 24-1, 24-2, and 24-3 are off, and switch circuits 22-1, 22-2, and 22-3 are off. Therefore, in each of the pixel circuits 20-1, 20-2, and 20-3, a current flows from the power supply line at the potential VEL to the gate of the MOSFET 202 via the MOSFETs 202, 204, and 203, and the potentials of the data line 12, the gate of the MOSFET 202 and the other end of the capacitance element 201 rise from the potential VINI. At this time, since the MOSFET 202 is in a state in which the gate and the drain are coupled to each other, that is, in a diode-coupled state, the voltage between the gate and the source in the MOSFET 202 converges to a threshold voltage Vth of the MOSFET 202. Since the MOSFET 202 is of the P-channel type, the threshold voltage Vth is a negative voltage. Since the source of the MOSFET 202 is supplied with the potential VEL, the potentials of the data line 12, the gate of the MOSFET 202, and the other end of the capacitance element 201 converge to a potential (VEL−|Vth|). Further, the potential of the anode of the light-emitting element 27 is maintained at the potential V0.

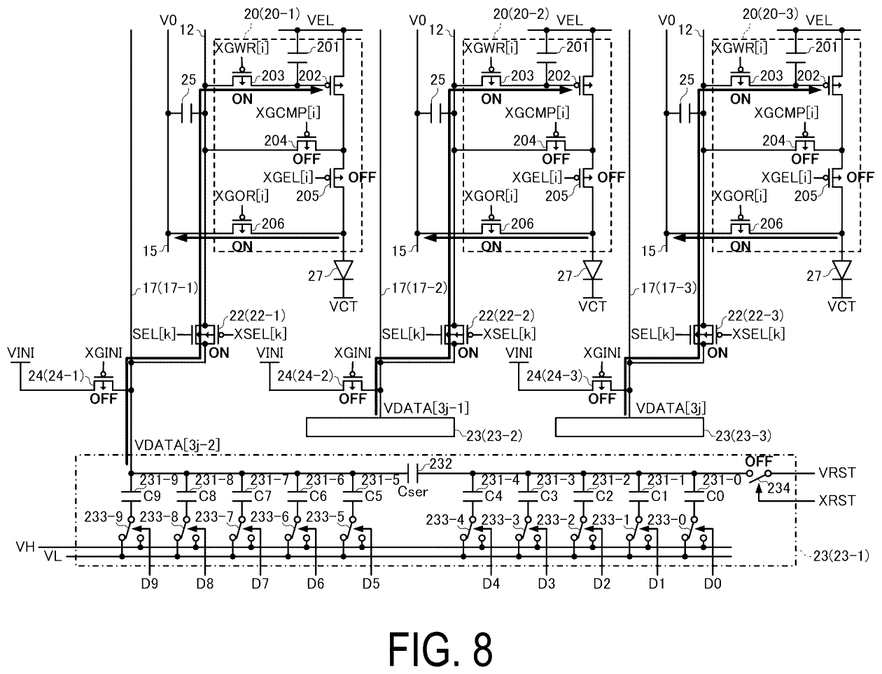

As illustrated in FIG. 5, in the horizontal scanning period 1H for the i-th row, the scanning signal XGWR[i] is at the L level in the writing period c. Further, the control signal XGOR[i] is at the L level, and the control signals XGCMP[i] and XGEL[i] are at the H level. Further, the control signals XGINI and XRST are at the H level. Further, the control signal SEL[k] is at the H level, and the control signal XSEL[k] is at the L level. Therefore, as illustrated in FIG. 8, in the writing period c, the MOSFETs 203 and 206 are on and the MOSFETS 204 and 205 are off in each of the pixel circuits 20-1, 20-2, and 20-3. Further, the data potential generating circuits 23-1, 23-2, and 23-3 generate the data potentials VDATA[3j−2], VDATA[3j−1], and VDATA[3j], respectively, and output the data potentials VDATA[3j−2], VDATA[3j−1], and VDATA[3j] to the data transfer lines 17-1, 17-2, and 17-3, respectively. Then, the data potential VDATA[3j−2] is transferred from the data transfer line 17-1 to the data line 12 coupled to the pixel circuit 20-1 via the switch circuit 22-1, and is supplied to the other end of the capacitance element 201 and the gate of the MOSFET 202 via the MOSFET 203 in the pixel circuit 20-1. Further, the data potential VDATA[3j−1] is transferred from the data transfer line 17-2 to the data line 12 coupled to the pixel circuit 20-2 via the switch circuit 22-2, and is supplied to the other end of the capacitance element 201 and the gate of the MOSFET 202 via the MOSFET 203 in the pixel circuit 20-2. Further, the data potential VDATA[3j] is transferred from the data transfer line 17-3 to the data line 12 coupled to the pixel circuit 20-3 via the switch circuit 22-3, and is supplied to the other end of the capacitance element 201 and the gate of the MOSFET 202 via the MOSFET 203 in the pixel circuit 20-3.

Here, immediately before both the MOSFET 203 of the pixel circuit 20-1 and the switch circuit 22-1 are on, the potential of the data line 12 is the potential (VEL−|Vth|), and when both the MOSFET 203 and the switch circuit 22-1 are on, the potential of the data transfer line 17-1 becomes the data potential VDATA[3j−2]. Therefore, the potential of the data line 12 becomes a potential ((Cd·(VEL−|Vth|)+Cst·VDATA[3j−2])/(Cd+Cst)) by capacitive coupling between the capacitor 25 and the capacitance elements 231-0 to 231-9, and 232 of the data potential generating circuit 23-1. Note that Cd is the capacitance value of the capacitor 25, and Cst is a combined capacitance value of the capacitance elements 231-0 to 231-9, and 232. Similarly, the potential of the data line 12 coupled to the pixel circuit 20-2 becomes a potential ((Cd. (VEL−|Vth|)+Cst·VDATA[3j−1])/(Cd+Cst)), and the potential of the data line 12 coupled to the pixel circuit 20-3 becomes a potential ((Cd·(VEL−|Vth|)+Cst·VDATA[3j])/(Cd+Cst)). Thereafter, when the scanning signal XGWR[j] is at the L level, in each of the pixel circuits 20-1, 20-2, and 20-3, the MOSFET 203 is off, and the potential of the gate of the MOSFET 202 is determined to be the above potentials.

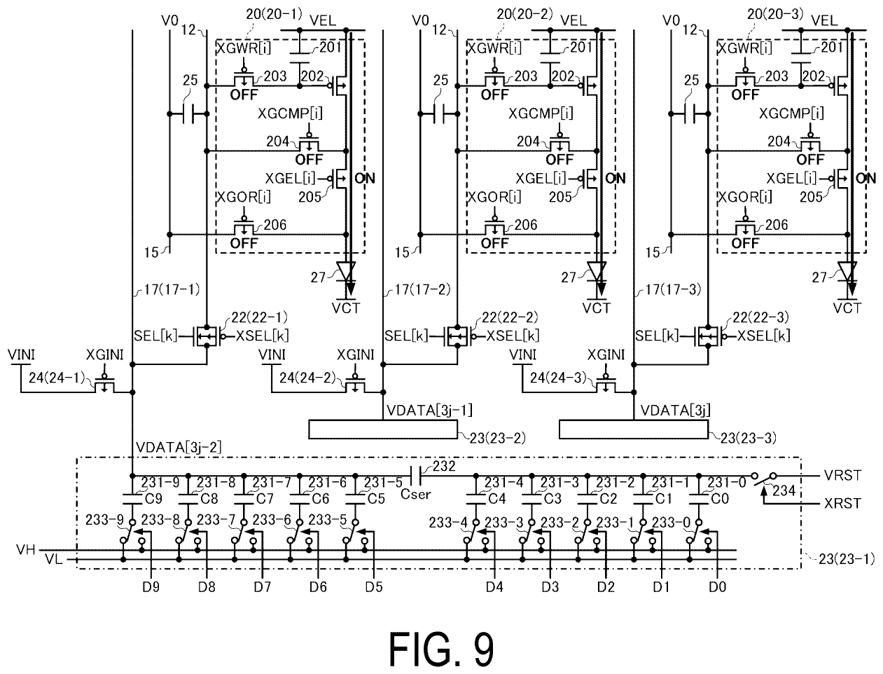

As illustrated in FIG. 5, in the horizontal scanning period 1H for the i-th row, the scanning signal XGWR[i] is at the H level in the light-emitting period d. Further, the control signal XGEL[i] is at the L level, and the control signals XGCMP[i] and XGOR[i] are at the H level. Therefore, as illustrated in FIG. 9, in the light-emitting period d, the MOSFET 205 is on and the MOSFETs 203, 204, and 206 are off in each of the pixel circuits 20-1, 20-2, and 20-3. Therefore, a current flowing from the source to the drain of the MOSFET 202 is supplied to the light-emitting element 27 via the MOSFET 205, and the light-emitting element 27 emits light. In the pixel circuit 20-1, the potential of the source of the MOSFET 202 is the potential VEL and the potential of the gate of the MOSFET 202 is the potential ((Cd·(VEL−|Vth|)+Cst·VDATA [3j−2])/(Cd+Cst)), and thus a current corresponding to the potential VDATA[3j−2] is to be supplied to the light-emitting element 27 in a state where the threshold voltage Vth of the MOSFET 202 is compensated. Similarly, in the pixel circuit 20-2, the potential of the gate of the MOSFET 202 is the potential ((Cd·(VEL−|Vth|)+Cst·VDATA[3j−1])/(Cd+Cst)), and thus a current corresponding to the potential VDATA[3j−1] is to be supplied to the light-emitting element 27 in a state where the threshold voltage Vth of the MOSFET 202 is compensated. Similarly, in the pixel circuit 20-3, the potential of the gate of the MOSFET 202 is the potential ((Cd·(VEL−|Vth|)+Cst·VDATA [3j])/(Cd+Cst)), and thus a current corresponding to the potential VDATA[3j] is to be supplied to the light-emitting element 27 in a state where the threshold voltage Vth of the MOSFET 202 is compensated.

Note that as illustrated in FIG. 5, control signals XGEL[i+1], XGOR[i+1], XGCMP[i+1] and scanning signal XGWR[i+1] in the horizontal scanning period 1H for an (i+1)-th row subsequent to the horizontal scanning period 1H for the i-th row have waveforms obtained by shifting each of the control signals XGEL[i], XGOR[i], XGCMP[i] and the scanning signal XGWR[i] by a time corresponding to a cycle of the horizontal scanning period 1H.

### 1-1-5. Structure of Display Panel

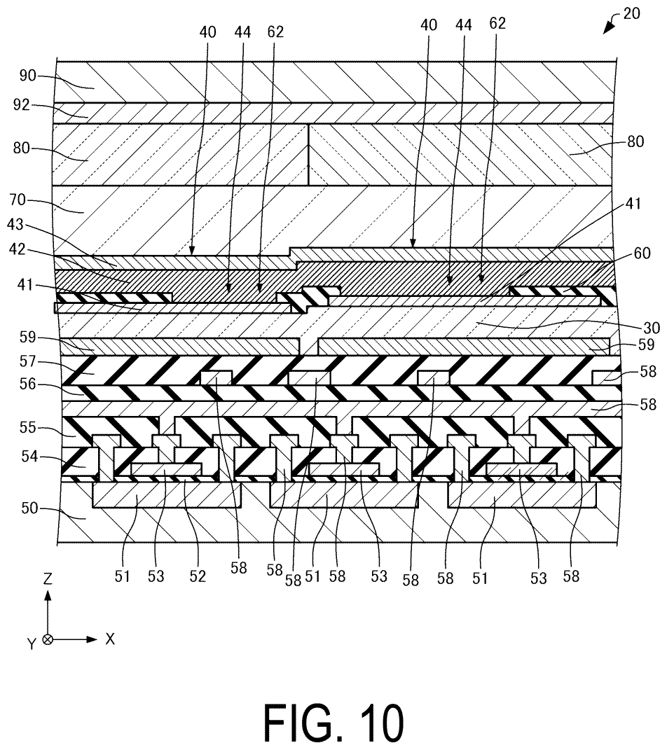

FIG. 10 is a cross-sectional view schematically illustrating a part of the display panel 2. As illustrated in FIG. 10, the display panel 2 includes, for example, a substrate 50, an interlayer insulating layers 54, 55, 56, and 57, a wiring layer 58, a reflective layer 59, an insulating layer 30, an organic EL element 40, an insulating layer 60, a sealing layer 70, a coloring layer 80, and a counter substrate 90.

The substrate 50 is, for example, a silicon substrate. The substrate 50 is provided with an impurity region 51 into which an impurity is ion-implanted. The impurity region 51 functions as the source or drain of each of the above-described MOSFETs 202 to 206. A gate insulating layer 52 is provided above the substrate 50. A material of the gate insulating layer 52 is, for example, silicon oxide. A gate electrode 53 is provided above the gate insulating layer 52. A material of the gate electrode 53 is, for example, metal, polysilicon or the like. The gate electrode 53 functions as the gate of each of the above-described MOSFETs 202 to 206.

The interlayer insulating layer 54 covers the gate insulating layer 52 and the gate electrode 53. The interlayer insulating layers 54, 55, 56, and 57 are stacked in this order from the substrate 50 side. The interlayer insulating layers 54, 55, 56, and 57 are, for example, silicon oxide layers.

The wiring layers 58 are provided above each of the interlayer insulating layer 54, the interlayer insulating layer 55, and the interlayer insulating layer 56. A material of the wiring layer 58 is, for example, metal such as aluminum or copper.

The reflective layer 59 is provided above the interlayer insulating layer 57. The reflective layer 59 is provided for each of the plurality of sub-pixels SP. FIG. 10 illustrates two sub-pixels SP. A material of the reflective layer 59 is, for example, metal such as aluminum. The reflective layer 59 reflects light generated by the organic EL element 40 and traveling toward the substrate 50 toward the coloring layer 80.

The insulating layer 30 is provided above the reflective layer 59. The insulating layer 30 differs in thickness among the red sub-pixel SP, the green sub-pixel SP, and the blue sub-pixel SP. The insulating layer 30 has, for example, a stacked structure in which a plurality of layers are stacked. The insulating layer 30 differs in the number of stacked layers among the red sub-pixel SP, the green sub-pixel SP, and the blue sub-pixel SP. The insulating layer 30 is, for example, a silicon oxide layer, a silicon nitride layer, a silicon oxynitride layer, or the like.

The organic EL element 40 is provided above the insulating layer 30. The organic EL element 40 is, for example, an OLED and functions as the above-described light-emitting element 27. The organic EL element 40 includes a pixel electrode 41, a light emission function layer 42, and a common electrode 43.

The pixel electrode 41 is provided above the insulating layer 30. The pixel electrode 41 is provided for each of the plurality of sub-pixels SP. The pixel electrode 41 transmits light generated in the light emission function layer 42. The pixel electrode 41 is a transparent electrode made of ITO or the like, for example. The pixel electrode 41 is an electrode on one side for injecting a current into the light emission function layer 42. ITO is an abbreviation of Indium Tin Oxide.

The light emission function layer 42 is provided above the pixel electrode 41. The light emission function layer 42 is continuously provided for the plurality of sub-pixels SP. The light emission function layer 42 is configured by stacking a plurality of light-emitting layers, for example. The light emission function layer 42 emits, for example, white light.

The common electrode 43 is provided above the light emission function layer 42. The common electrode 43 is a common electrode continuously provided for the plurality of sub-pixels SP. A material of the common electrode 43 is, for example, an alloy of magnesium and silver. The common electrode 43 is an electrode on another side for injecting a current into the light emission function layer 42.

The common electrode 43, the insulating layer 30, and the reflective layer 59 form an optical resonant structure. A thickness of the insulating layer 30 is adjusted so as to form a standing wave of a predetermined wavelength between the reflective layer 59 and the common electrode 43. Thus, light having a predetermined wavelength can be emitted from the organic EL element 40 for each of the plurality of sub-pixels SP.

The insulating layer 60 is provided above the pixel electrode 41. The insulating layer 60 is, for example, a silicon oxide layer, a silicon nitride layer, or a silicon oxynitride layer.

An opening portion 62 is formed at the insulating layer 60. The opening portion 62 penetrates through the insulating layer 60. The insulating layer 60 defines a light-emitting region 44 of the organic EL element 40. The light-emitting region 44 is a region overlapping the opening portion 62 of the organic EL element 40 in plan view.

The sealing layer 70 is provided above the common electrode 43. The sealing layer 70 is continuous for the plurality of sub-pixels SP. The sealing layer 70 is configured by stacking, for example, an inorganic layer and an organic layer. The sealing layer 70 may have a structure in which an organic layer is sandwiched between a pair of inorganic layers. The inorganic layer is, for example, a silicon oxide layer, a silicon nitride layer, or a silicon oxynitride layer. The inorganic layer protects the light emission function layer 42 from moisture, oxygen, and the like. The organic layer is, for example, a resin layer such as an acrylic-based resin layer. The organic layer improves flatness of an upper surface of the sealing layer 70.

The coloring layer 80 is provided above the sealing layer 70. The coloring layer 80 is a color filter configured to transmit a predetermined wavelength at each of the red sub-pixel SP, the green sub-pixel SP, and the blue sub-pixel SP. A material of the coloring layer 80 is, for example, a color resist.

The counter substrate 90 is provided above the coloring layer 80. In the illustrated example, the counter substrate 90 is bonded to the coloring layer 80 by a bonding layer 92. The counter substrate 90 and the bonding layer 92 transmit light emitted from the coloring layer 80. The counter substrate 90 functions as a protective substrate that protects the organic EL element 40 and the coloring layer 80.

Note that the display panel 2 is manufactured using, for example, a known semiconductor manufacturing process.

In the embodiment, as described above, the m×3n pixel circuits 20 included in the display panel 2 are divided into the q pixel circuit blocks BLK-1 to BLK-q, and each pixel circuit block BLK-k includes p×n light-emitting elements 27, p×n pixel circuits 20, and n switch circuits 22 corresponding to p×n red sub-pixels SP. In addition, each pixel circuit block BLK-k includes p×n light-emitting elements 27, p×n pixel circuits 20, and n switch circuits 22 corresponding to p×n blue sub-pixels SP. In addition, each pixel circuit block BLK-k includes p×n light-emitting elements 27, p×n pixel circuits 20, and n switch circuits 22 corresponding to p×n green sub-pixels SP. Therefore, each pixel circuit block BLK-k includes p×3n light-emitting elements 27, p×3n pixel circuits 20, and 3n switch circuits 22.

On the other hand, since the m×n pixels P are arrayed in the m rows and the n columns in the display region 112 of the display panel 2, the n pixels P are arranged in each row at an equal pitch in the X-axis direction, and the m pixels P are arranged in each column at an equal pitch in the Y-axis direction. One pixel P includes three light-emitting elements 27 corresponding to the red sub-pixel SP, the blue sub-pixel SP, and the green sub-pixel SP. Therefore, a layout area of the display panel 2 is reduced by matching a size of an arrangement region of the p×3n pixel circuits 20 and the 3n switch circuits 22 included in each pixel circuit block BLK-k with a size of an arrangement region of the p×3n light-emitting elements 27 included in the pixel circuit block BLK-k.

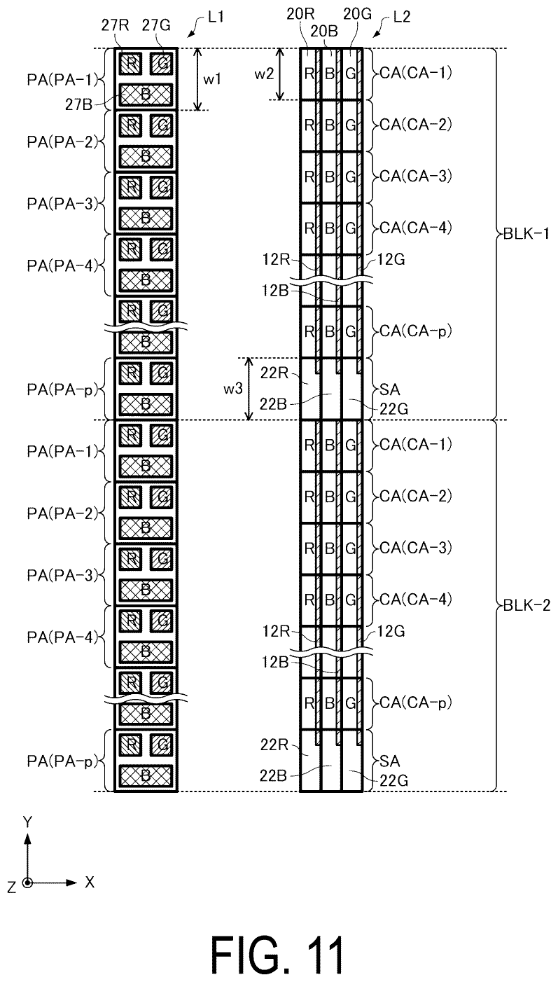

FIG. 11 is a plan view illustrating a configuration example of a layout of a part of the pixel circuit blocks BLK-1 and BLK-2. In FIG. 11, in the pixel circuit blocks BLK-1 and BLK-2, only a part of a layout corresponding to the pixels P for one column is illustrated. Note that in FIG. 11, the light-emitting elements 27 corresponding to the respective red, blue, and green sub-pixels SP are distinguished as light-emitting elements 27R, 27B, and 27G, respectively. Further, the pixel circuits 20 are distinguished as pixel circuits 20R, 20B, and 20G, respectively. Further, the switch circuits 22 respectively coupled to the pixel circuits 20R, 20B, and 20G are distinguished as switch circuits 22R, 22B, and 22G, respectively. Further, the data lines 12 respectively coupled to the switch circuits 22R, 22B, and 22G are distinguished as data lines 12R, 12B, and 12G, respectively.

In FIG. 11, as indicated by L1, the pixel circuit block BLK-1 includes p pixel arrangement regions PA. The p pixel arrangement regions PA are provided adjacent to each other in the Y-axis direction. In FIG. 11, for convenience, the p pixel arrangement regions PA are distinguished as PA-1 to PA-p, but layouts of the p pixel arrangement regions PA are the same, and the light-emitting elements 27R, 27B, and 27G are arranged in the pixel arrangement region PA.

Further, as indicated by L2, the pixel circuit block BLK-1 includes p pixel circuit arrangement regions CA. The p pixel circuit arrangement regions CA are provided adjacent to each other in the Y-axis direction at a layer lower than the p pixel arrangement regions PA. In FIG. 11, for convenience, the p pixel circuit arrangement regions CA are distinguished as CA-1 to CA-p, but layouts of the p pixel circuit arrangement regions CA are the same, and three pixel circuits 20R, 20B, and 20G are arranged adjacent to each other in the X-axis direction in the pixel circuit arrangement region CA.

Further, as indicated by L2 in FIG. 11, one switch circuit arrangement region SA is included in the pixel circuit block BLK-1. The switch circuit arrangement region SA is provided adjacent to the pixel circuit arrangement region CA-p in the Y-axis direction at a layer lower than the p pixel arrangement regions PA, and in the pixel circuit arrangement region SA, three switch circuits 22R, 22B, and 22G are arranged so as to be adjacent to each other in the X-axis direction, and so as to be adjacent to three pixel circuits 20R, 20B, and 20G in the pixel circuit arrangement region CA-p in the Y-axis direction, respectively.

In addition, in FIG. 11, as indicated by L2, in the pixel circuit block BLK-1, the data line 12R which is the data line 12 in the (3j−2)-th column extending in the Y-axis direction is arranged, the data line 12B which is the data line 12 in the (3j−1)-th column extending in the Y-axis direction is arranged, and the data line 12G which is the data line 12 in the 3j-th column extending in the Y-axis direction is arranged. The data line 12R is supplied with the data potential VDATA[3j−2] which is a signal for causing each of the p light-emitting elements 27R to emit light via the switch circuit 22R, the data line 12B is supplied with the data potential VDATA[3j−1] which is a signal for causing each of the p light-emitting elements 27B to emit light via the switch circuit 22B, and the data line 12G is supplied with the data potential VDATA[3j] which is a signal for causing each of the p light-emitting elements 27G to emit light via the switch circuit 22G. The data line 12R is arranged so as to overlap the p pixel circuits 20R and the switch circuit 22R, and the p pixel circuits 20R and the switch circuit 22R are coupled to the data line 12R. The data line 12B is arranged so as to overlap the p pixel circuits 20B and the switch circuit 22B, and the p pixel circuits 20B and the switch circuit 22B are coupled to the data line 12B. The data line 12G is arranged so as to overlap the p pixel circuits 20G and the switch circuit 22G, and the p pixel circuits 20G and the switch circuit 22G are coupled to the data line 12G.

As illustrated in FIG. 11, the pixel circuit block BLK-2 is arranged adjacent to the pixel circuit block BLK-1 in the Y-axis direction. The layout of the pixel circuit block BLK-1 and the layout of the pixel circuit block BLK-2 are exactly the same.

That is, in FIG. 11, as indicated by L1, the p pixel arrangement regions PA-1 to PA-p are included in the pixel circuit block BLK-2, and as indicated by L2, the p pixel circuit arrangement regions CA-1 to CA-p and the switch circuit arrangement region SA are included in the pixel circuit block BLK-2. In addition, in FIG. 11, as indicated by L2, in the pixel circuit block BLK-2, the data line 12R which is the data line 12 in the (3j−2)-th column extending in the Y-axis direction is arranged, the data line 12B which is the data line 12 in the (3j−1)-th column extending in the Y-axis direction is arranged, and the data line 12G which is the data line 12 in the 3j-th column extending in the Y-axis direction is arranged. The data line 12R included in the pixel circuit block BLK-2 is adjacent to the data line 12R included in the pixel circuit block BLK-1 along the Y-axis direction. Similarly, the data line 12B included in the pixel circuit block BLK-2 is adjacent to the data line 12B included in the pixel circuit block BLK-1 along the Y-axis direction. Similarly, the data line 12G included in the pixel circuit block BLK-2 is adjacent to the data line 12G included in the pixel circuit block BLK-1 along the Y-axis direction.

The data line 12R is supplied with the data potential VDATA[3j−2] which is the signal for causing each of the p light-emitting elements 27R to emit light via the switch circuit 22R, the data line 12B is supplied with the data potential VDATA[3j−1] which is the signal for causing each of the p light-emitting elements 27B to emit light via the switch circuit 22B, and the data line 12G is supplied with the data potential VDATA[3j] which is the signal for causing each of the p light-emitting elements 27G to emit light via the switch circuit 22G. The data line 12R is arranged so as to overlap the p pixel circuits 20R and the switch circuit 22R, and the p pixel circuits 20R and the switch circuit 22R are coupled to the data line 12R. The data line 12B is arranged so as to overlap the p pixel circuits 20B and the switch circuit 22B, and the p pixel circuits 20B and the switch circuit 22B are coupled to the data line 12B. The data line 12G is arranged so as to overlap the p pixel circuits 20G and the switch circuit 22G, and the p pixel circuits 20G and the switch circuit 22G are coupled to the data line 12G.

Note that although not illustrated, in each of the pixel circuit blocks BLK-1 and BLK-2, n columns are provided in each of which the p pixel arrangement regions PA-1 to PA-p are adjacent to each other in the X-axis direction, and n columns are provided in each of which the p pixel circuit arrangement regions CA-1 to CA-p and the switch circuit arrangement region SA are adjacent to each other in the X-axis direction. In addition, the pixel circuit blocks BLK-3 to BLK-q are arranged in this order so as to be adjacent to the pixel circuit block BLK-2 in the Y-axis direction. Then, layouts of the pixel circuit blocks BLK-3 to BLK-q are exactly the same as the layout of the pixel circuit blocks BLK-1 and BLK-2.

As illustrated in FIG. 11, in the pixel circuit block BLK-1, the p light-emitting elements 27R are arranged at a first pitch w1 in the Y-axis direction, and the p pixel circuits 20R are arranged at a second pitch w2 in the Y-axis direction.

Similarly, the p light-emitting elements 27B are arranged at the first pitch w1 in the Y-axis direction, and the p pixel circuits 20B are arranged at the second pitch w2 in the Y-axis direction. Similarly, the p light-emitting elements 27G are arranged at the first pitch w1 in the Y-axis direction, and the p pixel circuits 20G are arranged at the second pitch w2 in the Y-axis direction. The first pitch w1 matches with a width of one pixel arrangement region PA in the Y-axis direction, and the second pitch w2 matches with a width of one pixel circuit arrangement region CA in the Y-axis direction.

Here, since the second pitch w2 is smaller than the first pitch w1, a width w2×p in the Y-axis direction of the p pixel circuit arrangement regions CA is smaller than a widths w1×p in the Y-axis direction of the p pixel arrangement regions PA. A difference between the two widths is equal to a product (w1−w2)×p where (w1−w2) is a difference between the first pitch w1 and the second pitch w2 and p is the number of light-emitting elements 27R, therefore, by matching a width w3 in the Y-axis direction of the switch circuit arrangement region SA with (w1−w2)×p, a width in the Y-axis direction of a region including the p pixel arrangement regions PA matches with a width in the Y-axis direction of a region including the p pixel circuit arrangement regions CA and the switch circuit arrangement region SA.

In addition, in plan view, the switch circuit 22R overlaps at least one of the p light-emitting elements 27R, the switch circuit 22B overlaps at least one of the p light-emitting elements 27B, and the switch circuit 22G overlaps at least one of the p light-emitting elements 27G. To be specific, in plan view, the switch circuits 22R, 22B, and 22G overlap the light-emitting elements 27R, 27B, and 27G arranged in the pixel arrangement region PA-p, respectively.

In addition, in plan view, the switch circuit 22R is arranged in a region between an arrangement region of the p pixel circuits 20R included in the pixel circuit block BLK-1 and an arrangement region of the p pixel circuits 20R included in the pixel circuit block BLK-2. Similarly, in plan view, the switch circuit 22B is arranged in a region between an arrangement region of the p pixel circuits 20B included in the pixel circuit block BLK-1 and an arrangement region of the p pixel circuits 20B included in the pixel circuit block BLK-2. Similarly, in plan view, the switch circuit 22G is arranged in a region between an arrangement region of the p pixel circuits 20G included in the pixel circuit block BLK-1 and an arrangement region of the p pixel circuits 20G included in the pixel circuit block BLK-2.

Note that since the first pitch w1 and the second pitch w2 are different from each other, a positional shift between the pixel arrangement region PA-s and the pixel circuit arrangement region CA-s in the Y-axis direction increases as s increases. S is an integer from 1 to p.

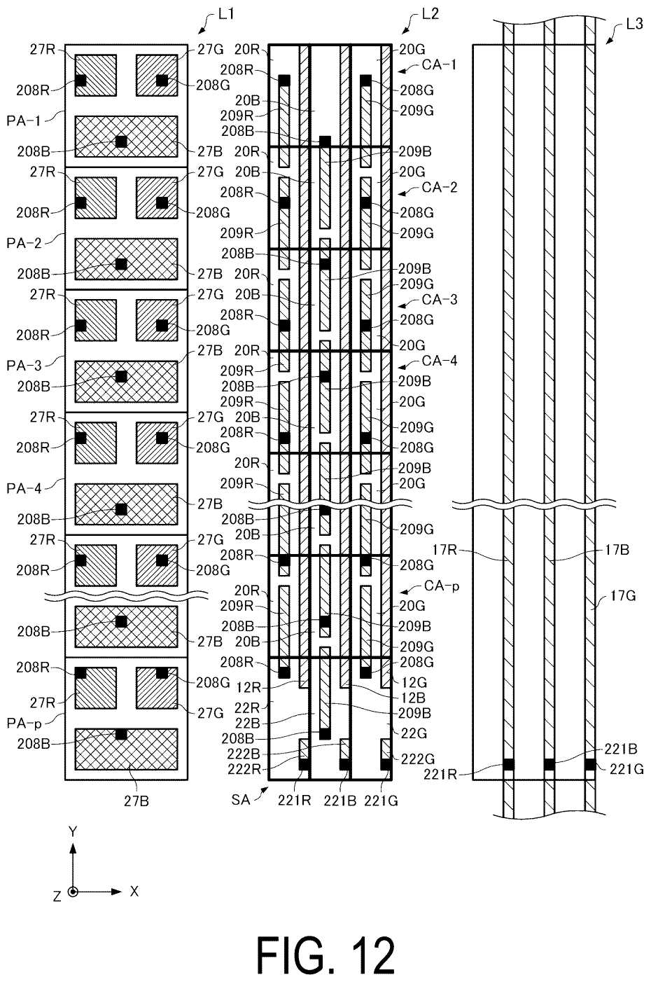

On the other hand, the pixel electrode 41 which is an anode of the light-emitting element 27R arranged in the pixel arrangement region PA-s is coupled to the drain of each of the MOSFETs 205 and 206 of the pixel circuit 20R arranged in the pixel circuit arrangement region CA-s. Similarly, the pixel electrode 41 which is an anode of the light-emitting element 27B arranged in the pixel arrangement region PA-s is coupled to the drain of each of the MOSFETs 205 and 206 of the pixel circuit 20B arranged in the pixel circuit arrangement region CA-s. Similarly, the pixel electrode 41 which is an anode of the light-emitting element 27G arranged in the pixel arrangement region PA-s is coupled to the drain of each of the MOSFETs 205 and 206 of the pixel circuit 20G arranged in the pixel circuit arrangement region CA-s. Therefore, in the embodiment, as illustrated in FIG. 12, positions of vias 208R, 208B, and 208G that respectively couple three anodes of the light-emitting elements 27R, 27B, and 27G to three wiring lines 209R, 209B, and 209G that are respectively coupled to drains of the MOSFETS 205 and 206 of the pixel circuits 20R, 20B, and 20G are shifted for each of the pixel arrangement region PA-s and the pixel circuit arrangement region CA-s.

FIG. 12 is a plan view illustrating a layout of a part of each pixel circuit block BLK-k in more detail, and the same components as those in FIG. 11 are denoted by the same reference numerals. In FIG. 12, as indicated by L2, the three wiring lines 209R, 209B, and 209G are provided at an upper wiring layer for each of the p pixel circuit arrangement regions CA-1 to CA-p. That is, each pixel circuit block BLK-k is provided with p wiring lines 209R, p wiring lines 209B, and p wiring lines 209G extending in the Y-axis direction. Then, the p wiring lines 209R have the same shape and are arranged at the second pitch w2 in the Y-axis direction. Similarly, the p wiring lines 209B have the same shape and are arranged at the second pitch w2 in the Y-axis direction. Similarly, the p wiring lines 209G have the same shape and are arranged at the second pitch w2 in the Y-axis direction.

In FIG. 12, as indicated by L1 and L2, each of the p light-emitting elements 27R overlaps any one of the p wiring lines 209R in a Z-axis direction, and the via 208R is arranged in the overlapping region. Similarly, each of the p light-emitting elements 27B overlaps any one of the p wiring lines 209B in the Z-axis direction, and the via 208B is arranged in the overlapping region. Similarly, each of the p light-emitting elements 27G overlaps any one of the p wiring lines 209G in the Z-axis direction, and the via 208G is arranged in the overlapping region. Therefore, relative positions of the wiring lines 209R, 209B, and 209G and the vias 208R, 208B, and 208G are different for each of the pixel arrangement regions PA and the pixel circuit arrangement regions CA. As described above, in each pixel circuit block BLK-k, the p vias 208R, the p vias 208B, and the p vias 208G are arranged with the positions thereof shifted, so that the p wiring lines 209R, the p wiring lines 209B, and the p wiring lines 209G can be arranged in a region including the pixel circuit arrangement regions CA-1 to CA-p and the switch circuit arrangement region SA, and therefore, an increase in layout area due to these wiring lines is suppressed.

Note that as far as the width w3=(w1−w2)×p of the switch circuit arrangement region SA is equal to or less than the first pitch w1, the p pixel arrangement regions PA-1 to PA-p can have the same layout, the p pixel circuit arrangement regions CA-1 to CA-p can have the same layout, and the p vias 208R, the p vias 208B, and the p vias 208G can be arranged with positions thereof shifted.

Additionally, as indicated by L2 in FIG. 12, in each pixel circuit block BLK-k, wiring lines 222R, 222B, and 222G coupled to input terminals of the respective switch circuits 22R, 22B, and 22G are provided in the switch circuit arrangement region SA. In addition, as indicated by L3, the data transfer lines 17R, 17B, and 17G are arranged so as to extend in the Y-axis direction at a wiring layer between the region including the pixel circuit arrangement regions CA-1 to CA-p and the switch circuit arrangement region SA, and the pixel arrangement regions PA-1 to PA-p. Then, as indicated by L2 and L3, in each pixel circuit block BLK-k, vias 221R, 221B, and 221G that couple the data transfer lines 17R, 17B, and 17G to the wiring lines 222R, 222B, and 222G, respectively, are provided at positions overlapping the switch circuit arrangement region SA in the Z-axis direction. As described above, in each pixel circuit block BLK-k, in plan view, the data transfer lines 17R, 17B, and 17G are arranged so as to overlap the region including the pixel circuit arrangement regions CA-1 to CA-p and the switch circuit arrangement region SA, and the pixel arrangement regions PA-1 to PA-p, and the vias 221R, 221B, and 221G are arranged at the positions overlapping the switch circuit arrangement region SA, thereby suppressing an increase in layout area due to the coupling with the data transfer lines 17R, 17B, and 17G.

In the first embodiment, the p light-emitting elements 27R in the (3j−2)-th column included in the pixel circuit block BLK-1 are an example of a “plurality of first light-emitting elements”, and the p light-emitting elements 27R in the (3j−2)-th column included in the pixel circuit block BLK-2 are an example of a “plurality of second light-emitting elements”. Further, the p pixel circuits 20R in the (3j−2)-th column included in the pixel circuit block BLK-1 are an example of “a plurality of first pixel circuits”, and the p pixel circuits 20R in the (3j−2)-th column included in the pixel circuit block BLK-2 are an example of “a plurality of second pixel circuits”. Further, the switch circuit 22R in the (3j−2)-th column included in the pixel circuit block BLK-1 is an example of a “first switch circuit”, and the switch circuit 22R in the (3j−2)-th column included in the pixel circuit block BLK-2 is an example of a “second switch circuit”. The data line 12R in the (3j−2)-th column included in the pixel circuit block BLK-1 is an example of a “first data line”, and the data line 12R in the (3j−2)-th column included in the pixel circuit block BLK-2 is an example of a “second data line”. Further, the Y-axis direction is an example of a “first direction”.

### 1-1-6. Effects

As described above, in the display device 1 of the first embodiment, the m pixel circuits 20 in the same column are not commonly coupled to the data transfer line 17, but the p pixel circuits 20 included in each pixel circuit block BLK-k are coupled to the data line 12 branched from the data transfer line 17 via the switch circuit 22. Therefore, the p pixel circuits 20 become loads coupled to the data line 12, but (n-p) pixel circuits 20 do not become loads coupled to the data line 12, so that a load of the data line 12 is reduced. In addition, since the switch circuit 22 included in each pixel circuit block BLK-k becomes a load coupled to the data transfer line 17, but the m pixel circuits 20 do not become loads coupled to the data transfer line 17, so that a load of the data transfer line 17 is also reduced. Therefore, according to the display device 1 of the first embodiment, since each data transfer line 17 and each data line 12 can be driven at high speed, for example, it is possible to display a high-definition image.

In addition, in the display device 1 of the first embodiment, in plan view, the switch circuit 22 overlaps at least one of the p light-emitting elements 27 in each pixel circuit block BLK-k. In particular, by setting the second pitch w2 at which the p pixel circuits 20 are arranged in the Y-axis direction to be smaller than the first pitch w1 at which the p light-emitting elements 27 are arranged in the Y-axis direction, the switch circuit 22 can be arranged in the switch circuit arrangement region SA obtained by excluding the region including the p pixel circuit arrangement regions CA from the region including the p pixel arrangement regions PA in plan view. Therefore, according to the display device 1 of the first embodiment, an increase in layout area of the display panel 2 due to the switch circuit 22 is suppressed. In the embodiment, when the switch circuit 22 overlaps the light-emitting element 27 in plan view, for example, any one of the source, gate, and drain of the N-channel MOSFET, the source, gate, and drain of the P-channel MOSFET, and wiring lines for electrically coupling them, which constitute the switch circuit 22, overlaps a light-emitting region of the light-emitting element 27 in plan view.

### 1-2. Second Embodiment

Hereinafter, in the display device 1 of a second embodiment, the same configurations as those of the first embodiment are denoted by the same reference numerals, the same descriptions as those of the first embodiment are omitted or simplified, and contents different from those of the first embodiment will be mainly described.

A perspective view of the display device 1 of the second embodiment is the same as FIG. 1 and a plan view of the display panel 2 in the second embodiment is the same as FIG. 2, thus illustration and description thereof will be omitted.

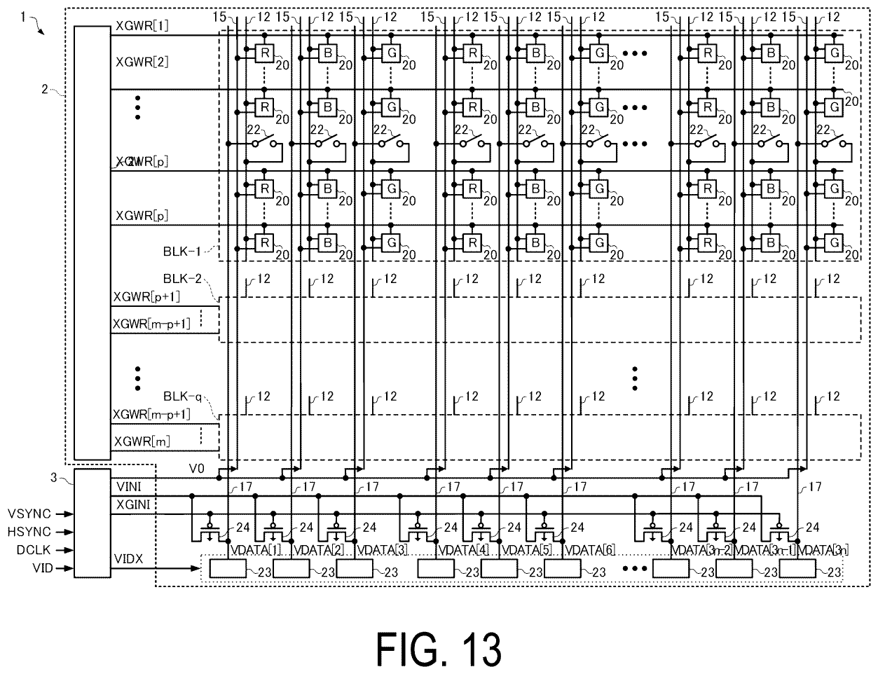

FIG. 13 is a block diagram illustrating an electrical configuration of the display device 1 of the second embodiment. An electrical coupling relationship of the display device 1 of the second embodiment is the same as that of the display device 1 of the first embodiment illustrated in FIG. 3, but as illustrated in FIG. 13, physical positions of 3n switch circuits 22 in each pixel circuit block BLK-k are different from those of the display device 1 of the first embodiment. k is an integer from 1 to q. To be specific, in each pixel circuit block BLK-k, the switch circuit 22 that controls electrical coupling between the data line 12 coupled to p pixel circuits 20 in the (3j−2)-th column and the data transfer line 17 in the (3j−2)-th column is arranged between two pixel circuits 20 included in the p pixel circuits 20. Similarly, the switch circuit 22 that controls electrical coupling between the data line 12 coupled to p pixel circuits 20 in the (3j−1)-th column and the data transfer line 17 in the (3j−1)-th column is arranged between two pixel circuits 20 included in the p pixel circuits 20. Similarly, the switch circuit 22 that controls electrical coupling between the data line 12 coupled to p pixel circuits 20 in the 3j-th column and the data transfer line 17 in the 3j-th column is arranged between two pixel circuits 20 included in the p pixel circuits 20. j is an integer from 1 to n.

Note that a configuration of the pixel circuit 20 and the data potential generating circuit 23 is the same as that in FIG. 4, and thus illustration and description thereof are omitted.

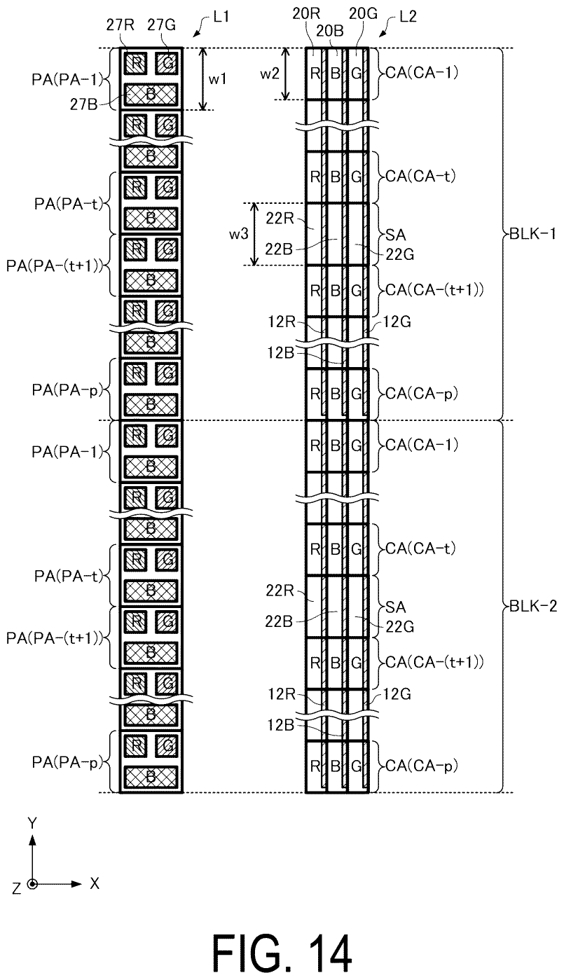

FIG. 14 is a plan view illustrating a configuration example of a layout of a part of the pixel circuit blocks BLK-1 and BLK-2 in the second embodiment. In FIG. 14, in the pixel circuit blocks BLK-1 and BLK-2, only a part of a layout corresponding to the pixels P for one column is illustrated.

In FIG. 14, as indicated by L1, similarly to FIG. 11, in the pixel circuit block BLK-1, the p pixel arrangement regions PA-1 to PA-p are provided adjacent to each other in the Y-axis direction.

In addition, as indicated by L2, in FIG. 14, in the pixel circuit block BLK-1, t pixel circuit arrangement regions CA-1 to CA-t are provided adjacent to each other in the Y-axis direction, (p-t) pixel circuit arrangement regions CA-(t+1) to CA-p are provided adjacent to each other in the Y-axis direction, and the switch circuit arrangement region SA is provided between a pixel circuit arrangement region CA-t and the pixel circuit arrangement region CA-(t+1), at a layer lower than the pixel circuit arrangement regions PA-1 to PA-p. t is a predetermined integer from 1 to p−1. As in FIG. 11, layouts of the p pixel circuit arrangement regions are the same, and three pixel circuits 20R, 20B, and 20G are arranged adjacent to each other in the X-axis direction in the pixel circuit arrangement region CA.

In the switch circuit arrangement region SA, three switch circuits 22R, 22B, and 22G are arranged adjacent to each other in the X-axis direction, adjacent to respective three pixel circuits 20R, 20B, and 20G in the pixel circuit arrangement region CA-t in the Y-axis direction, and adjacent to respective three pixel circuits 20R, 20B, and 20G in the pixel circuit arrangement region CA-(t+1) in the Y-axis direction. That is, in plan view, the switch circuit 22R is arranged in a region between two pixel circuits 20R among the p pixel circuits 20R. Similarly, in plan view, the switch circuit 22B is arranged in a region between two pixel circuits 20B among the p pixel circuits 20B. Similarly, in plan view, the switch circuit 22G is arranged in a region between two pixel circuits 20G among the p pixel circuits 20G.

As described above, the switch circuit arrangement region SA is provided between the pixel circuit arrangement region CA-t and the pixel circuit arrangement region CA-(t+1), and thus distances from the switch circuits 22R, 22B, and 22G to the pixel circuits 20R, 20B, and 20G at an end in the Y-axis direction are shorter than those in the first embodiment, and thus a difference in time constant at the time of writing data to the respective pixels P is reduced, and unevenness of an image displayed in the display region 112 is reduced. Note that in order to minimize the difference in time constant at the time of writing data to each pixel P, t=p/2 may hold, where p is an even number. That is, the switch circuit arrangement region SA may be provided so as to overlap a center in the Y-axis direction of a region including the p pixel arrangement regions PA-1 to PA-p.

In addition, as indicated by L2 in FIG. 14, in the pixel circuit block BLK-1, the data line 12R in the (3j−2)-th column extending in the Y-axis direction is arranged so as to overlap the p pixel circuits 20R and the switch circuit 22R, and the p pixel circuits 20R and the switch circuit 22R are coupled to the data line 12R. In addition, in the pixel circuit block BLK-1, the data line 12B in the (3j−1)-th column extending in the Y-axis direction is arranged so as to overlap the p pixel circuits 20B and the switch circuit 22B, and the p pixel circuits 20B and the switch circuit 22B are coupled to the data line 12B. In addition, in the pixel circuit block BLK-1, the data line 12G in the 3j-th column extending in the Y-axis direction is arranged so as to overlap the p pixel circuits 20G and the switch circuit 22G, and the p pixel circuits 20G and the switch circuit 22G are coupled to the data line 12G.

As illustrated in FIG. 14, the pixel circuit block BLK-2 is arranged adjacent to the pixel circuit block BLK-1 in the Y-axis direction. The layout of the pixel circuit block BLK-1 and the layout of the pixel circuit block BLK-2 are exactly the same. Further, although not illustrated, in each of the pixel circuit blocks BLK-1 and BLK-2, n columns are provided in each of which the p pixel arrangement regions PA-1 to PA-p are adjacent to each other in the X-axis direction, and n columns are provided in each of which the p pixel circuit arrangement regions CA-1 to CA-p and the switch circuit arrangement region SA are adjacent to each other in the X-axis direction. In addition, the pixel circuit blocks BLK-3 to BLK-q are arranged in this order so as to be adjacent to the pixel circuit block BLK-2 in the Y-axis direction. Then, layouts of the pixel circuit blocks BLK-3 to BLK-q are exactly the same as the layout of the pixel circuit blocks BLK-1 and BLK-2.

Also in the second embodiment, similarly to the first embodiment, in the pixel circuit block BLK-1, the second pitch w2 at which the p pixel circuits 20R are arranged in the Y-axis direction is smaller than the first pitch W1 at which the p light-emitting elements 27R are arranged in the Y-axis direction. Therefore, by matching the width w3 of the switch circuit arrangement region SA in the Y-axis direction with (w1−w2)×p, a width in the Y-axis direction of a region including p pixel arrangement regions PA matches with a width in the Y-axis direction of a region including p pixel circuit arrangement regions CA and the switch circuit arrangement region SA. s is an integer from 1 to p.

In addition, in plan view, the switch circuit 22R overlaps at least one of the p light-emitting elements 27R, the switch circuit 22B overlaps at least one of the p light-emitting elements 27B, and the switch circuit 22G overlaps at least one of the p light-emitting elements 27G. To be specific, in plan view, the switch circuit 22B overlaps the light-emitting element 27B arranged in the pixel arrangement region PA-t, and the switch circuits 22R and 22G overlap the light-emitting elements 27R and 27G arranged in the pixel arrangement region PA-(t+1), respectively.

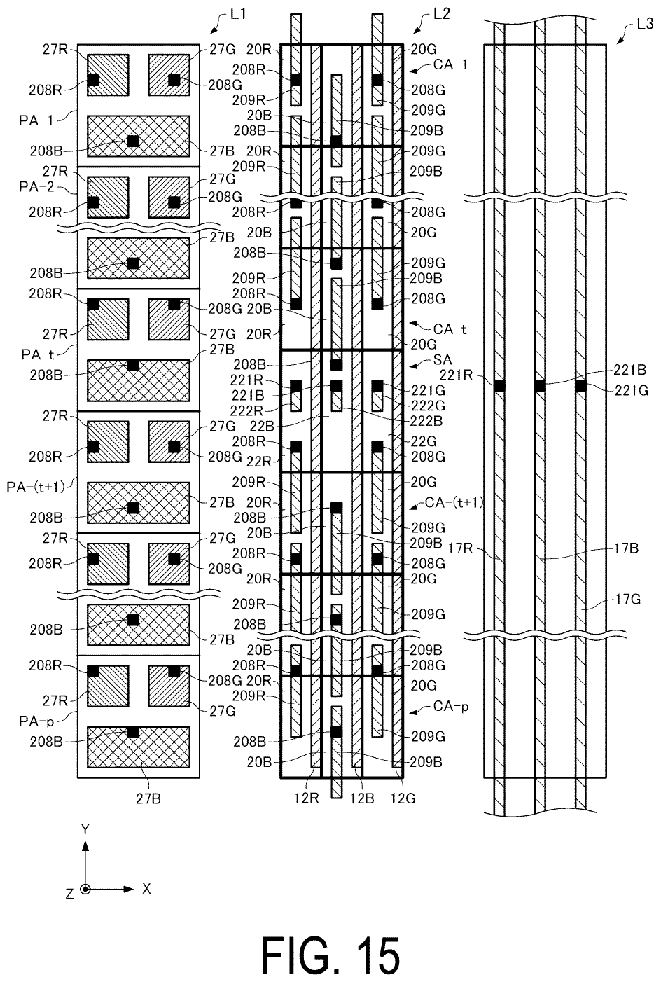

Also in the second embodiment, similar to the first embodiment, as illustrated in FIG. 15, positions of the vias 208R, 208B, and 208G that respectively couple the three anodes of the light-emitting elements 27R, 27B, and 27G to the three wiring lines 209R, 209G, and 209G that are respectively coupled to the drains of the MOSFETs 205 and 206 of the pixel circuits 20R, 20B, and 20G are shifted for each of the pixel arrangement region PA-s and the pixel circuit arrangement region CA-s.

FIG. 15 is a plan view illustrating a layout of a part of each pixel circuit block BLK-k in more detail, and the same components as those in FIG. 14 are denoted by the same reference numerals. In FIG. 15, as indicated by L2, the three wiring lines 209R, 209B, and 209G are provided at an upper wiring layer for each of the p pixel circuit arrangement regions CA-1 to CA-p. That is, each pixel circuit block BLK-k is provided with p wiring lines 209R, p wiring lines 209B, and p wiring lines 209R extending in the Y-axis direction. The p wiring lines 209R have the same shape and are arranged at the second pitch w2 in the Y-axis direction. Similarly, the p wiring lines 209B have the same shape and are arranged at the second pitch w2 in the Y-axis direction. Similarly, the p wiring lines 209G have the same shape and are arranged at the second pitch w2 in the Y-axis direction.

In FIG. 15, as indicated by L1 and L2, each of the p light-emitting elements 27R overlaps any one of the p wiring lines 209R in the Z-axis direction, and the via 208R is arranged in the overlapping region. Similarly, each of the p light-emitting elements 27B overlaps any one of the p wiring lines 209B in the Z-axis direction, and the via 208B is arranged in the overlapping region. Similarly, each of the p light-emitting elements 27G overlaps any one of the p wiring lines 209G in the Z-axis direction, and the via 208G is arranged in the overlapping region. Therefore, relative positions of the wiring lines 209R, 209B, and 209G and the vias 208R, 208B, and 208G are different for each of the pixel arrangement regions PA and the pixel circuit arrangement regions CA. As described above, in each pixel circuit block BLK-k, the p vias 208R, the p vias 208B, and the p vias 208G are arranged with the positions thereof shifted, so that the p wiring lines 209R, the p wiring lines 209B, and the p wiring lines 209G can be arranged in a region including the pixel circuit arrangement regions CA-1 to CA-p and the switch circuit arrangement region SA, and therefore, an increase in layout area due to these wiring lines is suppressed.

Note that as far as the width w3=(w1−w2)×p of the switch circuit arrangement region SA is equal to or less than the first pitch w1, the p pixel arrangement regions PA-1 to PA-p can have the same layout, the p pixel circuit arrangement regions CA-1 to CA-p can have the same layout, and the p vias 208R, the p vias 208B, and the p vias 208G can be arranged with positions thereof shifted.

Additionally, as indicated by L2 in FIG. 15, in each pixel circuit block BLK-k, the wiring lines 222R, 222B, and 222G coupled to the input terminals of the respective switch circuits 22R, 22B, and 22G are provided in the switch circuit arrangement region SA. In addition, as indicated by L3, the data transfer lines 17R, 17B, and 17G are arranged so as to extend in the Y-axis direction at a wiring layer between the region including the pixel circuit arrangement regions CA-1 to CA-p and the switch circuit arrangement region SA, and the pixel arrangement regions PA-1 to PA-p. Then, as indicated by L2 and L3, in each pixel circuit block BLK-k, the vias 221R, 221B, and 221G that couple the data transfer lines 17R, 17B, and 17G to the wiring lines 222R, 222B, and 222G, respectively, are provided at positions overlapping the switch circuit arrangement region SA in the Z-axis direction. As described above, in each pixel circuit block BLK-k, in plan view, the data transfer lines 17R, 17B, and 17G are arranged so as to overlap the region including the pixel circuit arrangement regions CA-1 to CA-p and the switch circuit arrangement region SA, and the pixel arrangement regions PA-1 to PA-p, and the vias 221R, 221B, and 221G are arranged at the positions overlapping the switch circuit arrangement region SA, thereby suppressing an increase in layout area due to the coupling with the data transfer lines 17R, 17B, and 17G.

In the second embodiment, the p light-emitting elements 27R in the (3j−2)-th column included in the pixel circuit block BLK-1 are an example of a “plurality of first light-emitting elements”, and the p light-emitting elements 27R in the (3j−2)-th column included in the pixel circuit block BLK-2 are an example of a “plurality of second light-emitting elements”. Further, the p pixel circuits 20R in the (3j−2)-th column included in the pixel circuit block BLK-1 are an example of “a plurality of first pixel circuits”, and the p pixel circuits 20R in the (3j−2)-th column included in the pixel circuit block BLK-2 are an example of “a plurality of second pixel circuits”. Further, the switch circuit 22R in the (3j−2)-th column included in the pixel circuit block BLK-1 is an example of a “first switch circuit”, and the switch circuit 22R in the (3j−2)-th column included in the pixel circuit block BLK-2 is an example of a “second switch circuit”. The data line 12R in the (3j−2)-th column included in the pixel circuit block BLK-1 is an example of a “first data line”, and the data line 12R in the (3j−2)-th column included in the pixel circuit block BLK-2 is an example of a “second data line”. Further, the Y-axis direction is an example of a “first direction”.

According to the display device 1 of the second embodiment described above, the same effects as those of the display device 1 of the first embodiment can be obtained. Furthermore, in the display device 1 of the second embodiment, in each pixel circuit block BLK-k, the switch circuit arrangement region SA is provided between two pixel circuit arrangement regions CA, and thus distances from the switch circuits 22 to the respective pixel circuits 20 at an end in the Y-axis direction are shortened, therefore, a difference in time constant at the time of writing data to the respective pixels P is reduced, and unevenness of an image displayed in the display region 112 is reduced.

### 2. Electronic Apparatus

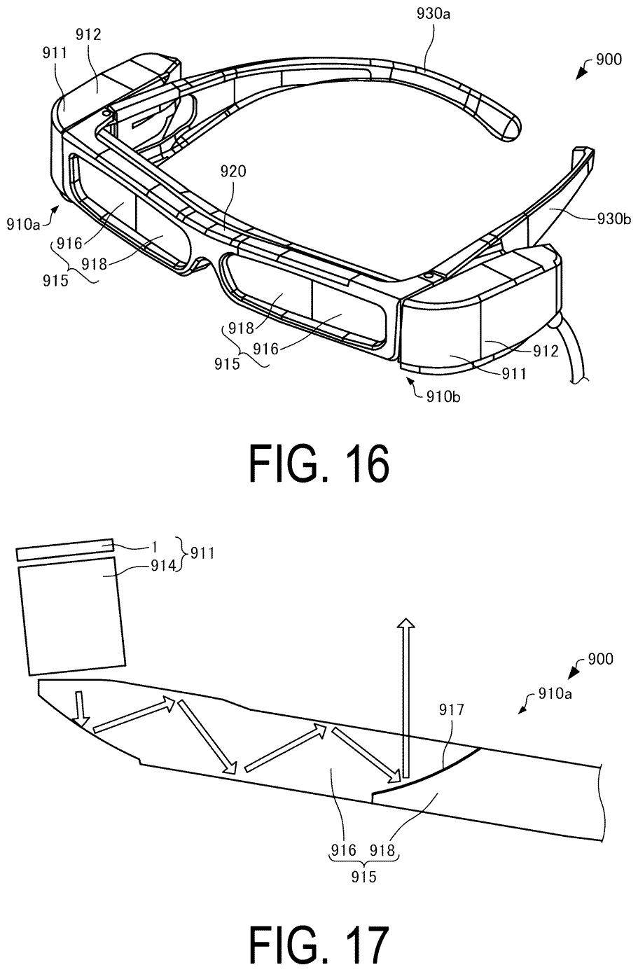

A head-mounted display will be described as an example of an electronic apparatus of the embodiment. FIG. 16 is a perspective view schematically illustrating a head-mounted display 900 as an example of the electronic apparatus of the embodiment.

As illustrated in FIG. 16, the head-mounted display 900 is a head-mounted display that has an outer appearance of an eyewear. The head-mounted display 900 is mounted on the head of a viewer. The viewer is a user who uses the head-mounted display 900. The head-mounted display 900 allows the viewer to visually recognize video light of a virtual image and to visually recognize an external image in a see-through manner.

The head-mounted display 900 includes, for example, a first display unit 910a, a second display unit 910b, a frame 920, a first temple 930a, and a second temple 930b.

The first display unit 910a and the second display unit 910b display images. Specifically, the first display unit 910a displays a virtual image for the right eye of the viewer. The second display unit 910b displays a virtual image for the left eye of the viewer. The display units 910a and 910b include, for example, an image forming device 911 and a light-guiding device 915.

The image forming device 911 generates image light. The image forming device 911 includes, for example, an optical system such as a light source and a projection device, and an external member 912. The external member 912 accommodates a light source and a projection device.

The light-guiding device 915 covers the front of the eyes of the viewer. The light-guiding device 915 guides the video light formed by the image forming device 911 and allows the viewer to visually recognize external light and the video light in an overlapping manner.

The frame 920 supports the first display unit 910a and the second display unit 910b. For example, the frame 920 surrounds the display units 910a and 910b. In the example illustrated in the drawing, the image forming device 911 of the first display unit 910a is attached to one end portion of the frame 920. The image forming device 911 of the second display unit 910b is attached to an other end portion of the frame 920.

The first temple 930a and the second temple 930b extend from the frame 920. In the example illustrated in the drawing, the first temple 930a extends from one end portion of the frame 920. The second temple 930b extends from another end portion of the frame 920.

The first temple 930a and the second temple 930b are put on the ears of the viewer when the head-mounted display 900 is worn by the viewer. The head of the viewer is positioned between the temples 930a and 930b.

FIG. 17 is a diagram schematically illustrating the image forming device 911 and the light-guiding device 915 of the first display unit 910a of the head-mounted display 900. The first display unit 910a and the second display unit 910b have basically the same configuration. Thus, the following description of the first display unit 910a can be applied to the second display unit 910b.

As illustrated in FIG. 17, for example, the image forming device 911 includes the display device 1 as a light source and a projection device 914 for image formation.

The projection device 914 projects, toward the light-guiding device 915, the video light output from the display device 1. The projection device 914 is, for example, a projection lens. As the lens constituting the projection device 914, a lens having an axially symmetric surface as a lens surface may be used.

The light-guiding device 915 is accurately positioned with respect to the projection device 914, for example, by being screwed to a lens barrel of the projection device 914. The light-guiding device 915 includes, for example, a video light-guiding member 916 that guides the video light and a see-through member 918 for see-through view.

The video light emitted from the projection device 914 is incident on the video light-guiding member 916. The video light-guiding member 916 is a prism that guides the video light toward the eyes of the viewer. The video light incident on the video light-guiding member 916 is repeatedly reflected on an inner surface of the video light-guiding member 916, and is then reflected by a reflective layer 917 to be emitted from the video light-guiding member 916. The video light emitted from the video light-guiding member 916 reaches the eyes of the viewer. The reflective layer 917 is constituted by, for example, a metal or a dielectric multilayer film. The reflective layer 917 may be a half mirror.

The see-through member 918 is adjacent to the video light-guiding member 916. The see-through member 918 is fixed to the video light-guiding member 916. An outer surface of the see-through member 918 is continuous with, for example, an outer surface of the video light-guiding member 916. The viewer sees external light through the see-through member 918. The video light-guiding member 916 also has a function of making the viewer see external light therethrough, in addition to the function of guiding video light. The head-mounted display 900 may be configured not to allow the viewer to see external light therethrough.

According to the electronic apparatus of the embodiment, since the display device 1 capable of driving the data lines 12 at high speed is included, for example, it is possible to display a high-definition image on the display device 1.

Note that the electronic apparatus including the display device 1 is not limited to the head-mounted display, and may be, for example, an EVF, a projector, a wearable display such as a smart watch, or an in-vehicle head-up display. EVF is an abbreviation for Electronic View Finder.

The present disclosure is not limited to the embodiment, and various modifications may be made within the scope of the present disclosure.

For example, in each of the above-described embodiments, the data potential generating circuit 23 is configured to include a capacitive DAC, but may be configured otherwise. For example, the j-th data potential generating circuit 23 may include a D/A converter circuit and an amplifier circuit, and the D/A converter circuit may acquire R data, B data, and G data of each of m pixels P in the j-th column included in the image data VIDX output from the control circuit 3 at timing designated by the control circuit 3 and perform D/A conversion in a time-division manner, and the amplifier circuit may amplify a potential after the D/A conversion to output the data potential VDATA[j].

Each embodiment and each modification example described above are merely examples, and are not intended as limiting. For example, each embodiment and each modification example can also be combined together as appropriate.

The present disclosure includes configurations that are substantially identical to the configurations described in the embodiment, for example, configurations with identical functions, methods and results, or with identical advantages and effects. Also, the present disclosure includes configurations obtained by replacing non-essential portions of the configurations described in the embodiment. In addition, the present disclosure also includes configurations that achieve the same effects as the configurations described in the embodiments or configurations that can achieve the same advantages. Further, the present disclosure includes configurations obtained by adding known techniques to the configurations described in the embodiment.

The following contents are derived from the embodiment and the modification examples described above.

An aspect of a display device includes
a plurality of first light-emitting elements,
a plurality of second light-emitting elements,
a data transfer line,
a first data line extending in a first direction,
a second data line extending in the first direction and adjacent to the first data line along the first direction,
a plurality of first pixel circuits coupled to the first data line and respectively coupled to the plurality of first light-emitting elements,
a plurality of second pixel circuits coupled to the second data line and respectively coupled to the plurality of second light-emitting elements,
a first switch circuit configured to control electrical coupling between the first data line and the data transfer line, and
a second switch circuit configured to control electrical coupling between the second data line and the data transfer line, wherein
the first data line is supplied with a signal for causing each of the plurality of first light-emitting elements to emit light from the data transfer line via the first switch circuit,
the second data line is supplied with a signal for causing each of the plurality of second light-emitting elements to emit light from the data transfer line via the second switch circuit, and
in a plan view, the first switch circuit overlaps at least one of the plurality of first light-emitting elements.

In this display device, the plurality of first pixel circuits and the plurality of second pixel circuits are not commonly coupled to the data transfer line, but the plurality of first pixel circuits are coupled to the first data line branched from the data transfer line via the first switch circuit, and the plurality of second pixel circuits are coupled to the second data line branched from the data transfer line via the second switch circuit. Therefore, the plurality of first pixel circuits become loads coupled to the first data line, but the plurality of second pixel circuits do not become loads coupled to the first data line, so that the loads of the first data line is reduced. Similarly, the plurality of second pixel circuits become loads coupled to the second data line, but the plurality of first pixel circuits do not become loads coupled to the second data line, so that the loads of the second data line are reduced. In addition, since the first switch circuit and the second switch circuit become loads coupled to the data transfer line, but the plurality of first pixel circuits and the plurality of second pixel circuits do not become loads coupled to the data transfer line, the loads of the data transfer line are also reduced. Therefore, according to the display device, since the data transfer line, the first data line, and the second data line can be driven at high speed, for example, it is possible to display a high-definition image.

In addition, in the display device, since the first switch circuit overlaps at least one of a plurality of the first light-emitting elements in the plan view, an increase in layout area due to the first switch circuit is suppressed.

In an aspect of the display device,
the plurality of first light-emitting elements may be arranged at a first pitch in the first direction, and
the plurality of first pixel circuits may be arranged at a second pitch in the first direction, and
the second pitch may be smaller than the first pitch.

In the display device, since the second pitch at which the plurality of first pixel circuits are arranged in the first direction is smaller than the first pitch at which the plurality of first light-emitting elements are arranged in the first direction, an arrangement region of the plurality of first pixel circuits is smaller than an arrangement region of the plurality of first light-emitting elements. Therefore, when the arrangement region of the plurality of first light-emitting elements is overlaid on an upper layer of the arrangement region of the plurality of first pixel circuits, the first switch circuit can be arranged in a region obtained by excluding the arrangement region of the plurality of first pixel circuits from the arrangement region of the plurality of first light-emitting elements in the plan view. Therefore, according to the display device, an increase in layout area due to the first switch circuit is suppressed.

In an aspect of the display device,
in the plan view, the first switch circuit may be arranged in a region between two among the first pixel circuits of the plurality of first pixel circuits.

According to this display device, since distances from the first switch circuit to pixel circuits at an end in the first direction are short, a difference in time constant at the time of writing data to the pixels is small, and unevenness of a displayed image is reduced.

In an aspect of the display device,
in the plan view, the first switch circuit may be arranged in a region between an arrangement region of the plurality of first pixel circuits and an arrangement region of the plurality of second pixel circuits.

In an aspect of the display device,
a product of a difference between the first pitch and the second pitch and the number of the first light-emitting elements may be equal to or less than the first pitch.

In the display device, when the arrangement region of the plurality of first light-emitting elements is overlaid on an upper layer of the arrangement region of the plurality of first pixel circuits, a plurality of wiring lines and a plurality of vias coupling the plurality of first light-emitting elements and the plurality of first pixel circuits, respectively, can be arranged in a region where the arrangement region of the plurality of first pixel circuits and the arrangement region of the plurality of first light-emitting elements overlap. Therefore, according to the display device, an increase in layout area due to the plurality of wiring lines and the plurality of vias is suppressed.

An aspect of an electronic apparatus includes
an aspect of the display device.

According to the electronic apparatus, since the display device capable of driving the data line at high speed is included, for example, it is possible to display a high-definition image on the display device.

What is claimed is:

1. A display device, comprising:
a plurality of first light-emitting elements;
a plurality of second light-emitting elements;
a data transfer line;
a first data line extending in a first direction;
a second data line extending in the first direction and adjacent to the first data line along the first direction;
a plurality of first pixel circuits coupled to the first data line and respectively coupled to the plurality of first light-emitting elements;
a plurality of second pixel circuits coupled to the second data line and respectively coupled to the plurality of second light-emitting elements;
a first switch circuit configured to control electrical coupling between the first data line and the data transfer line; and
a second switch circuit configured to control electrical coupling between the second data line and the data transfer line, wherein
the first data line is supplied with a signal for causing each of the plurality of first light-emitting elements to emit light from the data transfer line via the first switch circuit,
the second data line is supplied with a signal for causing each of the plurality of second light-emitting elements to emit light from the data transfer line via the second switch circuit, and
in a plan view, the first switch circuit overlaps at least one of the plurality of first light-emitting elements.

2. The display device according to claim 1,
wherein the plurality of first light-emitting elements are arranged at a first pitch in the first direction,
the plurality of first pixel circuits are arranged at a second pitch in the first direction, and
the second pitch is smaller than the first pitch.

3. The display device according to claim 1,
wherein in the plan view, the first switch circuit is arranged in a region between two first pixel circuits of the plurality of first pixel circuits.

4. The display device according to claim 1,
wherein in the plan view, the first switch circuit is arranged in a region between an arrangement region of the plurality of first pixel circuits and an arrangement region of the plurality of second pixel circuits.

5. The display device according to claim 2,
wherein a product of a difference between the first pitch and the second pitch and the number of the first light-emitting elements is equal to or less than the first pitch.

6. An electronic apparatus comprising the display device according to claim 1.
